(19) United States
(12) Patent Application Publication
(10) Pub. No.: US 2023/0290275 A1
(43) Pub. Date: Sep. 14, 2023

(54) SYSTEMS AND METHODS FOR TRAINING A USER TO OPERATE A TELEOPERATED SYSTEM

(71) Applicant: Intuitive Surgical Operations, Inc., Sunnyvale, CA (US)

(72) Inventors: Sida Li, San Jose, CA (US); Michael Carmody, San Jose, CA (US); Sabrina A. Cismas, Saratoga, CA (US); Lisa M. Divone, San Jose, CA (US); Henry C. Lin, San Jose, CA (US); Cameron Loui, Montara, CA (US); Oliver J. Wagner, Mountain View, CA (US)

(21) Appl. No.: 18/007,251

(22) PCT Filed: Jul. 28, 2021
(86) PCT No.: PCT/US2021/043512

§ 371 Date: Jan. 27, 2023

Related U.S. Application Data
(60) Provisional application No. 63/058,228, filed on Jul. 29, 2020.

(51) Int. Cl. G09B 23/28

(52) U.S. Cl. CPC G09B 23/285

(57) ABSTRACT

A system comprises a user control system including an input control device for controlling motion of a virtual medical instrument through a virtual passageway. The system further comprises a display for displaying a graphical user interface and a plurality of training modules. The graphical user interface includes a representation of the virtual medical instrument and a representation of the virtual passageway. The system further comprises a non-transitory, computer-readable storage medium that stores a plurality of instructions executable by one or more computer processors. The instructions for performing operations comprise navigating the virtual medical instrument through the virtual passageway based on commands received from the user control system and evaluating one or more performance metrics for tracking the navigation of the virtual medical instrument through the virtual passageway.

### CROSS-REFERENCE TO RELATED APPLICATIONS

This application claims priority to and the benefit of U.S. Provisional Application No. 63/058,228, filed Jul. 29, 2020, which is incorporated by reference herein in its entirety.

### FIELD

The present disclosure is directed to systems and methods for training a user to operate a teleoperated system and more particularly to training a user to operate a teleoperated system by using a simulator system.

### BACKGROUND

Minimally invasive medical techniques are intended to reduce the amount of tissue that is damaged during medical procedures, thereby reducing patient recovery time, discomfort, and harmful side effects. Such minimally invasive techniques may be performed through natural orifices in a patient anatomy or through one or more surgical incisions. Through these natural orifices or incisions clinicians may insert minimally invasive medical instruments (including surgical, diagnostic, therapeutic, or biopsy instruments) to reach a target tissue location. One such minimally invasive technique is to use a flexible and/or steerable elongate device, such as a catheter, that can be inserted into anatomic passageways and navigated toward a region of interest within the patient anatomy. Control of such an elongate device by medical personnel involves the management of several degrees of freedom including at least the management of insertion and retraction of the elongate device as well as steering of the device. In addition, different modes of operation may also be supported.

Accordingly, it would be advantageous to provide a system to train a user, such as a surgeon, to use a teleoperated system having input controls that support intuitive control and management of flexible and/or steerable elongate devices, such as steerable catheters, that are suitable for use during minimally invasive medical techniques. It would be further advantageous for the training system to simulate movement of the input controls and to simulate a graphical user interface that may be used by the surgeon during minimally invasive medical procedures.

### SUMMARY

The embodiments of the invention are best summarized by the claims that follow the description.

Consistent with some embodiments, a system is provided. The system includes a user control system including an input control device for controlling motion of a virtual medical instrument through a virtual passageway. The system further includes a display for displaying a graphical user interface and a plurality of training modules. The graphical user interface includes a representation of the virtual medical instrument and a representation of the virtual passageway. The system further includes a non-transitory, computer-readable storage medium that stores a plurality of instructions executable by one or more computer processors. The instructions for performing operations include training a user to navigate a medical instrument through the virtual passageway. The instructions for performing operations further include determining a performance metric for tracking navigation of the virtual medical instrument through the virtual passageway.

Other embodiments include corresponding computer systems, apparatus, and computer programs recorded on one or more computer storage devices, each configured to perform the actions of the methods.

It is to be understood that both the foregoing general description and the following detailed description are exemplary and explanatory in nature and are intended to provide an understanding of the present disclosure without limiting the scope of the present disclosure. In that regard, additional aspects, features, and advantages of the present disclosure will be apparent to one skilled in the art from the following detailed description.

### BRIEF DESCRIPTIONS OF THE DRAWINGS

FIG. 1A illustrates a simulator system including a user control system and a computing device according to some embodiments.

FIG. 1B illustrates a top view of a user control system according to some embodiments.

FIG. 2A illustrates a module graphical user interface displayable on a display device according to some embodiments.

FIG. 2B illustrates a training exercise graphical user interface displayable on a display device according to some embodiments.

FIGS. 3A-3E illustrate various training exercises with various virtual passageways according to some embodiments.

FIG. 4 illustrates a set of instructions for performing a training exercise according to some embodiments.

FIG. 5 illustrates a method for tracking a user performance of a training exercise according to some embodiments.

FIG. 6 illustrates a training exercise displayable on a display device including a global view of a virtual passageway and a view from a distal tip of a virtual instrument according to some embodiments.

FIGS. 7A-7G illustrate various training exercises with various virtual passageways according to some embodiments.

FIG. 8 illustrates an exercise displayable on a display device including a view from a distal tip of a virtual instrument and a contact indicator according to some embodiments.

FIGS. 9A-9B illustrate training exercises including performance metrics regarding a user's control of a virtual instrument according to some embodiments.

FIG. 10 illustrates a profile summary including performance metrics according to some embodiments.

FIG. 11 illustrates a graphical user interface displayable on a display device according to some embodiments.

FIG. 12 is a simplified diagram of a computer-assisted, teleoperated system according to some embodiments.

Embodiments of the present disclosure and their advantages are described in the detailed description that follows. It should be appreciated that like reference numerals are used to identify like elements illustrated in one or more of the figures for purposes of illustrating but not limiting embodiments of the present disclosure.

### DETAILED DESCRIPTION

In the following description, specific details describe some embodiments consistent with the present disclosure. Numerous specific details are set forth in order to provide a thorough understanding of the embodiments. It will be apparent to one skilled in the art, however, that some embodiments may be practiced without some or all of these specific details. The specific embodiments disclosed herein are meant to be illustrative but not limiting. One skilled in the art may realize other elements that, although not specifically described, are within the scope and the spirit of this disclosure. In addition, to avoid unnecessary repetition, one or more features shown and described in association with one embodiment may be incorporated into other embodiments unless specifically described otherwise or if the one or more features would make an embodiment non-functional. In some instances, well known methods, procedures, components, and circuits have not been described in detail so as not to unnecessarily obscure aspects of the embodiments.

A simulator system may assist with accelerating user learning and improving user performance of a teleoperated system. The simulator system allows users (e.g., surgeons, clinicians, practitioners, nurses, etc.) to familiarize themselves with the controls of a user control system of the teleoperated system. The simulator system also allows users to familiarize themselves with a graphical user interface (GUI) of the teleoperated system. Thus, the users may practice operating the teleoperated system via the simulator system prior to operating the teleoperated system during a medical procedure on a patient. The simulator system may provide users with training modules that teach users to efficiently navigate challenging patient anatomy by navigating a virtual instrument, such as a virtual medical instrument (e.g., a virtual endoscope), through a virtual passageway. Performance metrics may be tracked to evaluate the user's performance and to further aid the user in his or her training.

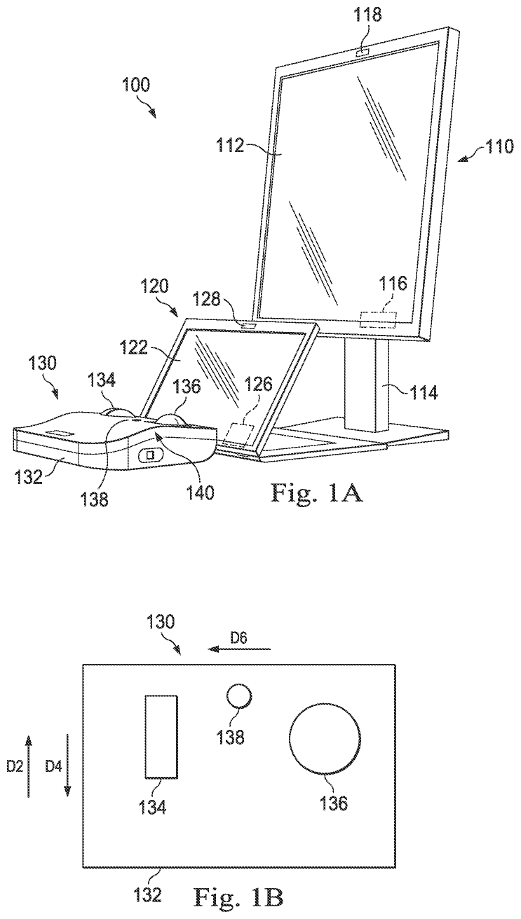

FIG. 1A illustrates a system 100 including a computing system 110 (which may be a computing device), a computing system 120 (which may be a computing device), and a user control system 130. FIG. 1B is a top view of the user control system 130. The computing system 110 includes a display device 112, which may include a display screen, and an optional stand 114. The computing system 110 may include a processing system 116 including one or more processors. The computing system 110 may include power components, communication components (e.g., transmitters, receivers, transceivers) for receiving and/or transmitting data, memory/storage components for storing data, and/or other components (not shown) to support the function of the computing systems 110. In some embodiments, the computing system 110 is a monitor but may be any other suitable computing system, such as a television, a remote computing device (e.g., a laptop or a mobile phone), etc. The computing system 120 includes a display device 122, which may include a display screen. The computing system 120 may include a processing system 126 including one or more processors. The computing system 120 may include power components, communication components (e.g., transmitters, receivers, transceivers) for receiving and/or transmitting data, memory/storage components for storing data, and/or other components (not shown) to support the function of the computing systems 120. In some embodiments, the computing system 120 is a remote computing device (e.g., a laptop, mobile phone, etc.) but may be any other suitable computing system, such as a monitor, a television, etc.

While the discussion below may be made with respect to one display device (e.g., the display device 122), that discussion similarly applies to the other display device (e.g., the display device 112). For example, anything displayed on the display device 122 may additionally or alternatively be displayed on the display device 112. In some examples, the display devices 112, 122 may operate in the same manner and/or may include similar features. For example, one or both of the display devices 112, 122 may include touch screens.

Additionally or alternatively, the computing system 110 may include an image capture device 118 (e.g., a camera) to track the gaze of the user as the user is operating the user control system 130. For example, the camera 118 may track the user's gaze, and the processing system 116 may determine whether the user is looking at the display screen 112 or the display screen 122. Additionally or alternatively, the computing system 120 may include an image capture device 128 (e.g., a camera) to track the gaze of the user as the user is operating the user control system 130. For example, the camera 128 may track the user's gaze, and the processing system 126 may determine whether the user is looking at the display screen 112 or the display screen 122.

As shown in FIGS. 1A and 1B, the user control system 130 includes a housing 132, an input control device 134, an input control device 136, a state button 138, and a ridge 140. In some embodiments, the input control device 134 may be a scroll wheel, and the input control device 136 may be a track ball. The state button 138 may be used to control a state of a virtual instrument (e.g., a passive state or an active state). In some embodiments, the ridge 140 may be included to ergonomically support a user's arms/wrists as the user operates the user control system 130. Any other ergonomic features may additionally or alternatively be included on the user control system 130. In some examples, the input control device 134 has an infinite length of travel and may be spun in either direction (e.g., forward and backward). In some cases, the input control device 136 has an infinite length of travel and may be spun about any number of axes. In some examples, the most common movements of the input control device 136 may be combinations of a left and right rotation, a forward and backward rotation, and a spin in place rotation. In alternative embodiments, one or both of the input control devices 134, 136 may be touch pads, joysticks, touch screens, and/or the like.

In some examples, the user control system 130 may be communicatively coupled to the computing system 120 through a wireless and/or a wired connection. In such examples, the computing system 120 may also be communicatively coupled to the computing system 110 through a wireless and/or a wired connection. In some cases, the user control system 130 may be coupled to the computing system 110 via the computing system 120. In other embodiments, the user control system 130 may be coupled to the computing system 110 directly through a wireless and/or a wired connection. As will be described in further detail below, a user (e.g., a surgeon, clinician, nurse, etc.) may interact with one or more of the computing system 110, the computing system 120, and the user control system 130 to control a virtual instrument. In some examples, the virtual instrument is a virtual medical instrument.

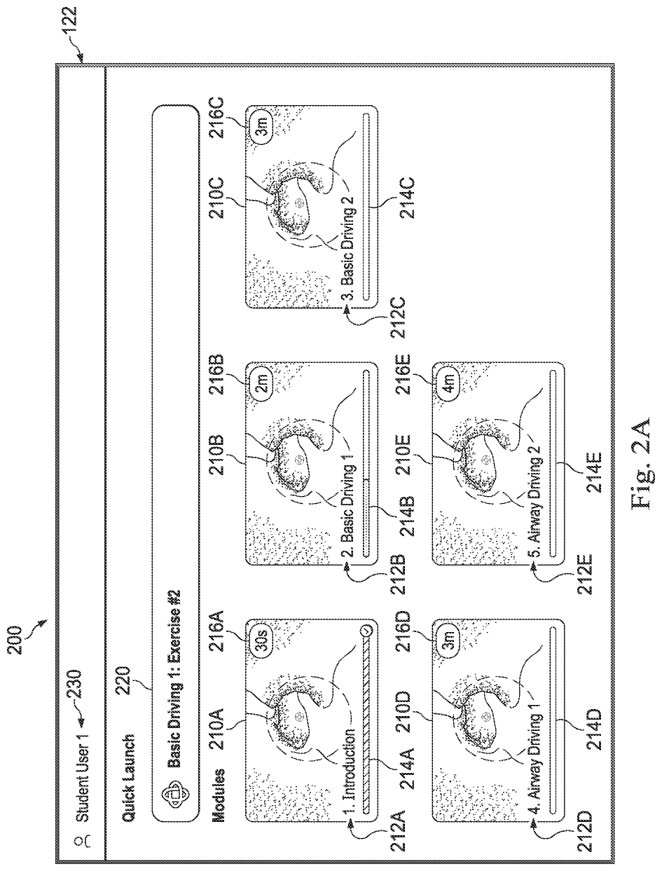

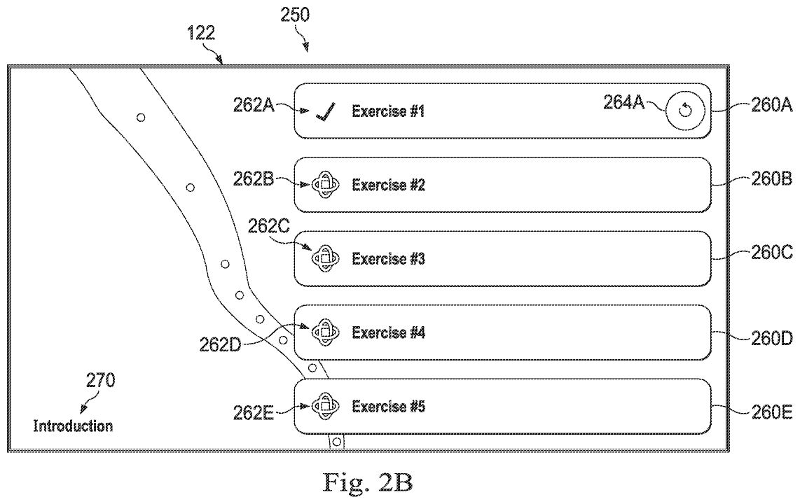

FIG. 2A illustrates a dynamic graphical user interface (GUI) 200. The GUI 200 may be displayed on the display device 112, the display device 122, or both. The GUI 200 includes a plurality of module icons 210A-E. Each module icon 210A-210E may represent at least one module. The modules may be implemented as software executable by one or more processors of the system 100. One or more of the modules may include one or more training exercises designed to familiarize a user (e.g., a surgeon, clinician, nurse, etc.) with a teleoperated system. The exercises may provide simulations that allow the user to manipulate a virtual instrument through various virtual passageways and/or toward various virtual targets. The exercises allow the user to practice using a teleoperated system prior to using the teleoperated system in a medical procedure. In some embodiments, the system 100 may present five training modules—an Introduction Module represented by a module icon 210A, a Basic Driving 1 Module represented by a module icon 210B, a Basic Driving 2 Module represented by a module icon 210C, an Airway Driving 1 Module represented by a module icon 210D, and an Airway Driving 2 Module represented by a module icon 210E. In other embodiments, the system 100 may offer more than five or fewer than five training modules (e.g., one module, two modules, three modules, four modules, six modules, seven modules, etc.). The system 100 may present any one or more of the modules listed above or may include any other modules that are not listed above. In other examples, the module icons 210A-210E may represent any one or more of the modules listed above and/or any other modules not listed. Additionally or alternatively, one or more module icons may represent more than one module.

The modules may be sorted based on difficulty. In some examples, the difficulty of the modules may be based on the complexity of a driving path through the virtual passageways. In other examples, the difficulty of the modules may be based on whether multiple control inputs are needed, which may be input via the input control devices 134, 136, while the virtual instrument traverses the virtual passageway. For example, a module that requires multiple control inputs may be more difficult than a module that requires one control input. Additionally or alternatively, the difficulty of the modules may be based on the complexity of the control inputs. In still other examples, the difficulty of the modules may be based on a target time to complete a module. For example, a module with a short target time to complete may be more difficult than a module with a longer target time to complete. The difficulty may be based on any combination of the factors above and/or any other similar factors or combinations of factors. Additionally or alternatively, the modules may be sorted based on one or more user learning objectives. In some examples, the user learning objectives may include basic concepts (e.g., operating the input control devices 134, 136, driving the virtual instrument through relatively straight virtual passageways, etc.), complex concepts (e.g., driving the virtual instrument through curved virtual passageways, navigating a virtual anatomical model of a patient, etc.), muscle memory, cognition, etc. Each module may include one or more user learning objectives.

In some cases, the Airway Driving 2 Module may be the most difficult module to complete when compared to the other modules. The Airway Driving 2 Module may thus be more difficult than the Airway Driving 1 Module, which may be more difficult than the Basic Driving 2 Module, which may be more difficult than the Basic Driving 1 Module, which may be more difficult than the Introduction Module. The user may be prompted to complete the modules in order of difficulty (e.g., from least difficult to most difficult), thereby starting with the Introduction Module and ending with the Airway Driving 2 Module. In other examples, the user may complete the modules in any order. In some examples, each module may be repeated any number of desired times. In alternative embodiments, each module only becomes available after the user has completed the preceding module. For example, the Basic Driving 1 Module may be available only after the user completes the Introduction Module. In further embodiments, subsets of modules may become available when preceding subsets of modules are completed. For example, the Airway Driving 1 and 2 Modules may be available only after the user completes the Basic Driving 1 and 2 Modules.

As shown in FIG. 2A, each module icon 210A-210E includes a title 212A-212E indicating the general subject matter covered by each respective module. Each module icon 210A-210E may also include a status indicator, such as a status bar 214A-214E. As seen in FIG. 2A, the status bar 214A, for example, is fully filled, which may indicate that each exercise within the Introduction Module has been completed. As further seen in FIG. 2A, the status bar 214B is partially filled, which may indicate that some but not all of the exercises within the Basic Driving 1 Module have been completed. The status bar 214C is empty, which may indicate that none of the exercises within the Basic Driving 2 Module have been started and/or completed. In some examples, one or more of the module icons 210A-210E may further include a time indicator 216A-216E. Each time indicator 216A-216E may illustrate the estimated overall time it may take a user to complete all exercises within a module. For example, the time indicator 216A may indicate that it will take a user about 30 seconds to complete all of the exercises in the Introduction Module. In alternative embodiments, each time indicator 216A-216E may illustrate the estimated time it may take the user to complete the next available exercise in each module.

In some examples, the display screen 122 may be a touch screen. In such examples, the user may select the module icon 210A, for example, by touching the module icon 210A on the display screen 122. In other embodiments the user may select the module icon 210A using a stylus, a mouse controlling a cursor on the display screen 122, and/or by any other suitable method (e.g., voice activation, eye tracking, etc.). Any one of the module icons 210A-210E may be selected using any one or more of the above selection methods. Additionally or alternatively, the display screen 112 may be a touch screen. In such examples, the module icons 210A-210E may displayed on the display screen 112, and the user may select the module icon 210A, for example, by touching the module icon 210A on the display screen 112. In other embodiments the user may select the module icon 210A using a stylus, a mouse controlling a cursor on the display screen 112, and/or by any other suitable method (e.g., voice activation, eye tracking, etc.). Any one of the module icons 210A-210E may be selected using any one or more of the above selection methods.

In some embodiments, the GUI 200 may further include an icon 220, which may be a quick launch icon. The quick launch icon 220 may indicate the next suggested exercise set to be completed by the user. For example, if the user has completed Exercise 1 of the Basic Driving 1 Module, one of the next exercises the user may complete is Exercise 2 of the Basic Driving 1 Module. If the user exits the Basic Driving 1 Module and returns to the GUI 200 (e.g., the “home screen”), then the user may directly launch Exercise 2 of the Basic Driving 1 Module by selecting the quick launch icon 220. The quick launch icon 220 may provide the user with a quicker access path to select the next suggested exercise, rather than navigating to the particular module and then to the particular exercise.

The GUI 200 may further include user identification information 230. The user identification information 230 may indicate which user is logged in to one or both of the computing systems 110, 120. In some embodiments, each user is associated with his or her own individual profile, which includes a unique login associated with each profile. The computing system 110 and/or the computing system 120 may include any number of logins/user profiles associated with any number of users. Thus, more than one user may log in to the computing systems 110, 120. In some embodiments, only one user may be logged in at a time. In other embodiments, multiple users may be logged in to the same system at the same time. In some examples, a user may log in to the computing system 120 using his or her profile to access the modules within the computing system 120. Once the user is logged in, the user identification information 230 may indicate that the user is logged in (e.g., by including the user's name, username, profile ID, etc., on the GUI 220). The user can log in and log out of the computing system 120 at any time. If the user logs out without completing all the modules/exercises, the user's progress may be saved and recalled when the user logs in again. This allows the user to continue to complete modules/exercises without needing to repeat modules/exercises the user has already completed. In other examples, if the user has completed all the modules/exercises, the user can log in again to repeat any one or more of the modules/exercises.

Each of the modules represented by module icons 210A-E may include a plurality of training exercises. For example, after the module icon 210A is selected, the display screen 122 displays a dynamic GUI 250, as shown in FIG. 2B. The GUI 250 includes a plurality of training exercise icons 260A-E. Each exercise icon 260A-E may represent at least one training exercise. In some embodiments, the exercise icons 260A-E may form a listing of the exercises that are included within the Introduction Module. The GUI 250 may include a module identifier 270 to indicate which module the user has selected. In FIG. 2B, the module identifier 270 indicates that the user has selected the Introduction Module, which the user may access by selecting the module icon 210A. Therefore, the GUI 250 shown in FIG. 2B illustrates exercises included within the Introduction Module. In some embodiments, the Introduction Module may include five exercises—Exercise 1, Exercise 2, Exercise 3, Exercise 4, and Exercise 5. The number and type of exercises within each module may vary. For example, the Introduction Module may include more or fewer than five exercises (e.g., one exercise, two exercises, three exercises, four exercises, six exercises, or any other number of exercises). In some examples, the exercise icon 260A represents Exercise 1, the exercise icon 260B represents Exercise 2, the exercise icon 260C represents Exercise 3, the exercise icon 260D represents Exercise 4, and the exercise icon 260E represents Exercise 5. In other examples, the exercise icons 260A-E may represent any one or more of the exercises listed above and/or any other exercises not listed. Additionally or alternatively, one or more of the exercise icons 260A-E may represent more than one exercise.

Each exercise icon 260A-E may include a corresponding status indicator 262A-262E. The status indicators 262A-E may illustrate whether a particular exercise has been completed or not. The status indicator 262A, for example, may be a check mark or any other symbol representing a completed exercise, and may indicate that Exercise 1 has been completed. Additionally, in some examples, when an exercise is completed, a replay icon 264A may be included within the exercise icon corresponding to the completed exercise (e.g., the exercise icon 260A). By selecting the replay icon 264A, the user may repeat Exercise 1. The status indicator 262B may be a symbol that represents an incomplete exercise (e.g., intertwined rings, an “X,” or the like), and may indicate that Exercise 2 has not been completed. Because Exercise 2 has not been completed, the exercise icon 260B may not include a replay icon. In some embodiments, the user may complete the exercises in any order, and each exercise may be repeated any number of desired times. In alternative embodiments, each exercise only becomes available after the user has completed the preceding exercise. For example, Exercise 2 may be available only after the user completes Exercise 1. In further embodiments, subsets of exercises may become available when preceding subsets of exercises are completed. For example, Exercises 4 and 5 may be available only after the user completes Exercises 1-3.

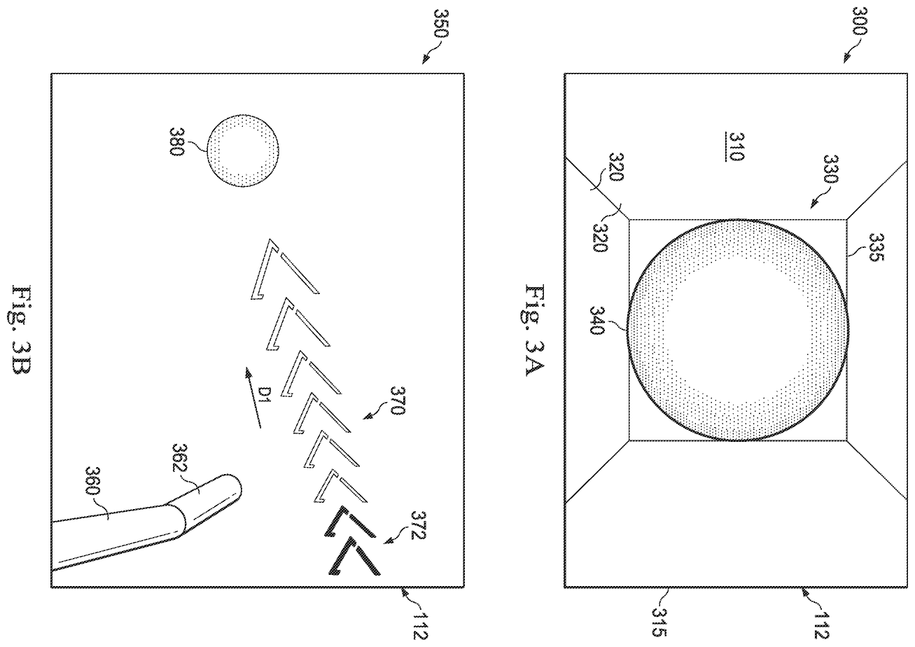

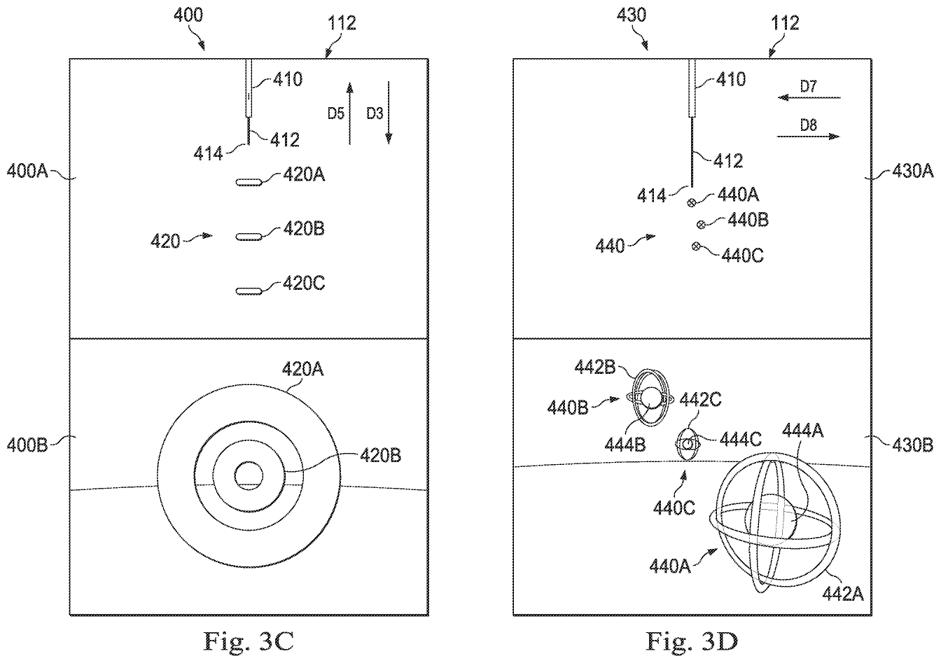

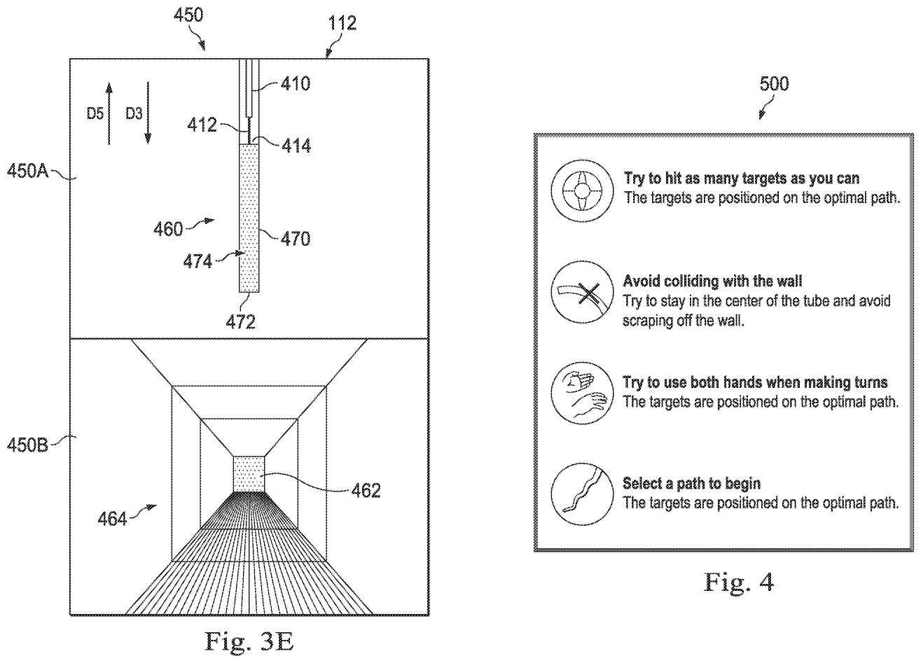

FIGS. 3A-3E illustrate portions of various training exercises according to some embodiments. As shown in FIG. 3A, the display screen 112 illustrates a dynamic GUI 300 for an insertion/retraction exercise. The insertion/retraction exercise may be the first exercise in the Introduction Module represented by module icon 210A. The insertion/retraction exercise may be activated when the user selects the first exercise of the Introduction Module. A goal of the Introduction Module is to familiarize the user with the user control system 130. For example, the Introduction Module may teach the user how to operate the user control system 130 to control a virtual instrument. As discussed above with respect to FIG. 2B, the user may activate the Introduction Module by selecting the module icon 210A on the display screen 122.

In some embodiments, the user may select the Exercise 1 of the Introduction Module by selecting the exercise icon 260A. In some embodiments, the insertion/retraction exercise GUI 300 may be shown on the display screen 112 when the user activates Exercise 1 of the Introduction Module. The GUI 300 may provide training for using the input control device 134. As discussed above, the input control device 134 may roll forward and backward to control insertion/retraction of a virtual instrument.

As seen in FIG. 3A, when the insertion/retraction exercise is activated, the display screen 112 displays a lumen 310 of a virtual passageway 315 defined by a surface 320. In the embodiment seen in FIG. 3A, the lumen 310 has a rectangular cross section, but in other embodiments, the lumen 310 may have a different cross sectional shape, such as a circular cross section. A target 340 is included within a distal portion 330 of the virtual passageway 315. In some examples, as the user rolls the input control device 134 forward (representing an insertion motion of the virtual instrument), for example, an opening 335 at the end of the virtual passageway 315 may grow larger. The target 340 may then grow larger as the opening 335 grows larger. This may give the user the sense that the virtual instrument is moving toward the target 340 as the virtual instrument approaches the target 340. In some embodiments, when the virtual instrument reaches the target 340, the display screen 112 may display an effect to indicate that the virtual instrument has reached the target 340. For example, the display screen 112 may alter the display of the target 340, such as by exploding the target 340, imploding the target 340, changing an opacity of the target 340, changing a color of the target 340, etc. Additionally or alternatively, one or more other effects may be used when the virtual instrument reaches the target 340, such as an audio signal, a textual indicator on the display screen 112, providing haptic feedback to the user through the input control device 134 and/or the user control system 130, and/or any other similar effect. In other examples, as the user rolls the input control device 134 backward (representing a retraction motion of the virtual instrument), the opening 335 may grow smaller as the virtual instrument backs away from the target 340. The target 340 may then grow smaller as the opening 335 grows smaller.

In some embodiments, the user may select Exercise 2 of the Introduction Module by selecting the exercise icon 260B. Exercise 2 of the Introduction Module may be an instrument bending exercise. In some embodiments, a portion of a dynamic GUI 350 for the instrument bending exercise may be shown on the display screen 112 when the user activates the second exercise of the Introduction Module. The GUI 350 provides training for use of the input control device 136.

As seen in FIG. 3B, when the bending exercise is activated, the GUI 350 on the display screen 112 displays a virtual instrument 360 including a distal portion 362. In some examples, as the user rolls the input control device 136 in a direction, the distal portion 362 of the virtual instrument 360 bends in a corresponding direction on the display screen 112. The input control device 136 can be rolled to actuate the virtual instrument in yaw (left and right) and pitch (up and down). For example, if the user rolls the input control device 136 to the left (e.g., in a direction D1), the distal portion 362 of the virtual instrument 360 bends to the left. The GUI 350 further includes a set of directional arrows 370 that indicate which direction the user should roll the input control device 136. As shown in FIG. 3B, the directional arrows 370 are pointed in the direction D1, indicating the user should roll the input control device 136 in the direction D1. A progress indicator 372 illustrates how far the user has rolled the input control device 136 in the direction D1. For example, the progress indicator 372 may be illustrated by shading in one or more arrows of the directional arrows 370, as shown in FIG. 3A. In other examples, the progress indicator 372 may be illustrated as a pattern, a color, or any other visual indicator shown on one or more of the directional arrows 370. In further examples, the progress indicator 372 may be a non-visual indicator, such as an audible indicator, a haptic indicator, or the like. As the user continues to roll the input control device 136 in the direction D1, the progress indicator 372 may extend along the directional arrows 370, eventually reaching a target 380. The progress indicator 372 may be a color, a pattern, or any other similar indicator that may extend along, in, on, above, or below the progress indicator 372. The progress indicator 372 may point in any other direction in addition to the direction D1, as well.

When the user has rolled the input control device 136 a threshold distance in the direction D1, the virtual instrument 360 may be deemed to have “reached” the target 380. The display screen 112 may display an effect to indicate that the virtual instrument 360 has “reached” the target 380. For example, the target 380 may illuminate/change color. Additionally or alternatively, one or more other effects may be used when the virtual instrument 360 “reaches” the target 380, such as an audio signal, a textual indicator on the display screen 112, the display screen 112 illustrates an effect (e.g., the target 380 explodes, implodes, fades, disappears, etc.), the user receives haptic feedback through the input control device 136 and/or the user control system 130, and/or any other similar effect.

In some embodiments, after the virtual instrument 360 “reaches” the target 380, the distal portion 362 stops bending even if the user continues to roll the input control device 136 in the direction D1. In alternative embodiments, as the user rolls the input control device 136 in the direction D1, the distal portion 362 of the virtual instrument 360 may continue to bend in the direction D1 past the target 380.

In some embodiments, the user may select Exercise 3 of the Introduction Module by selecting the exercise icon 260C. Exercise 3 of the Introduction Module may be a linear navigation exercise. In some embodiments, a portion of a dynamic GUI 400 for the linear navigation exercise may be shown on the display screen 112 when the user activates Exercise 3 of the Introduction Module. The linear navigation exercise GUI 400 provides training for using the input control device 134 and the input control device 136 at the same time.

As seen in FIG. 3C, the display screen 112 displays the linear navigation exercise GUI 400, including a first portion 400A and a second portion 400B. In some embodiments, the first portion 400A illustrates a global perspective view of a virtual elongate device 410 (which may be a virtual catheter, for example), a virtual instrument 412, and a virtual passageway 420. As shown in FIG. 3C, the virtual instrument 412 may extend from the virtual catheter 410. The virtual instrument 412 includes a distal portion 414. In some examples, the second portion 400B illustrates a view from a distal tip of the virtual instrument 412. Both the first portion 400A and the second portion 400B may be updated in real time as the virtual instrument 412 traverses the virtual passageway 420. In some examples, the first portion 400A may be displayed alone on the display screen 112, or the second portion 400B may be displayed alone on the display screen 122. In other examples, both the first portion 400A and the second portion 400B may be concurrently displayed on the display screen 112, in split-screen form as shown in FIG. 3C.

In the linear navigation exercise using GUI 400, the GUI 400 may provide training to teach the user to navigate the virtual instrument 412 through the virtual passageway 420. In some examples, the virtual passageway 420 is defined by a plurality of sequentially-aligned virtual rings 420A-420C. In some embodiments, the rings 420A-420C may be linearly aligned. The linear navigation exercise may be completed when the distal portion 414 of the virtual instrument 412 traverses through each of the rings 420A-420C. In some examples, the system 120 and/or the system 110 determines that the distal portion 414 successfully traversed the virtual passageway 420 when the distal portion 414 passes through and/or contacts each ring 420A-420C. In some embodiments, when the distal portion 414 passes through and/or contacts each ring 420A-420C, an effect is presented to indicate that the distal portion 414 passed through and/or contacted each ring 420A-420C. For example, the display screen 112 may illustrate an effect (e.g., each ring 420A-420C explodes, implodes, fades, disappears, etc.), an audio signal may be played, the display screen 112 may display a textual indicator, the rings 420A-420C may change color, the user may receive haptic feedback through the input control device 134, the input control device 136, and/or the housing 132 of the user control system 130, and/or any other similar indication may be presented.

As discussed above, the input control device 134 may control insertion/retraction of the virtual instrument 412. In some examples, scrolling of the input control device 134 forward away from the user increases the insertion depth (insertion) of a distal end of the virtual instrument 412 and scrolling of the input control device 134 backward toward the operator decreases the insertion depth (retraction) of the distal end of the virtual instrument 412. For example, when the user rolls the input control device 134 in a direction D2 (FIG. 1B), the virtual instrument 412 may extend further out from the virtual catheter 410 in a direction D3. In some examples, when the user rolls the input control device 134 in a direction D4 (FIG. 1B), the virtual instrument 412 may retract within the virtual catheter 410 in a direction D5. In some embodiments, the virtual passageway 420 is aligned with a longitudinal axis of the virtual instrument 412. In such embodiments, the user may only need to actuate the input control device 134 to navigate the virtual instrument 412 through the virtual passageway 420. In other embodiments, the virtual passageway 420 may not be aligned with the longitudinal axis of the virtual instrument 412. In such embodiments, the user may actuate both input control devices 134, 136 to navigate the virtual instrument 412 through the virtual passageway 420. For example, when the input control devices 134, 136 are actuated at the same time, actuation of the input control device 136 causes the distal portion 414 of the virtual instrument 412 to change orientation as the insertion depth of the virtual instrument 412 changes. This results in a change of direction of the virtual instrument 412.

In some embodiments, the user may select Exercise 4 of the Introduction Module by selecting the exercise icon 260D. Exercise 4 of the Introduction Module may be a non-linear navigation exercise. In some embodiments, a portion of a dynamic GUI 430 for the non-linear navigation exercise may be shown on the display screen 112 when the user activates Exercise 4 of the Introduction Module. The GUI 430 provides training for using the input control device 134 and the input control device 136 at the same time.

As seen in FIG. 3D, the display screen 112 illustrates the GUI 430 including a first portion 430A and a second portion 430B. In some embodiments, the first portion 430A illustrates a global perspective view of the virtual catheter 410, the virtual instrument 412, and a virtual passageway 440. In some examples, the second portion 430B illustrates a view from the distal tip of the virtual instrument 412. Both the first portion 430A and the second portion 430B may be updated in real time as the virtual instrument 412 traverses the virtual passageway 440.

In the non-linear navigation exercise using GUI 430, the GUI 430 may provide training to teach the user to navigate the virtual instrument 412 through the virtual passageway 440. In some examples, the virtual passageway 440 is defined by a plurality of sequentially-aligned virtual targets 440A-440C. As shown in FIG. 3D, the target 440A may include outer rings 442A and an inner nucleus 444A. Similarly, the target 440B may include outer rings 442B and an inner nucleus 444B. Additionally, the target 440C may include outer rings 442C and an inner nucleus 444C. The targets 440A-440C may be any size and shape. For example, one or more of the inner nuclei 444A-444C may be a sphere, a cube, a pyramid, a rectangular prism, etc. The outer rings 442A-442C may be circular, square, triangular, etc. The shape of the outer rings 442A-442C may correspond to the shape of the nuclei 444A-444C—e.g., if the nucleus 444A is a sphere, the outer ring 442A may be a circular ring. Alternatively, the shape of the outer rings 442A-442C may be different than the shape of the nuclei 444A-444C—e.g., if the nucleus 440A is a cube, the outer ring 442A may be a triangular ring. In alternative examples, one or more of the targets 440A-440C may be a sphere with varying opacity where the center of the sphere is solid and the outer edge of the sphere is translucent.

In some embodiments, the targets 440A-440C may be non-linearly aligned. The non-linear navigation exercise may be completed when the distal portion 414 of the virtual instrument 412 traverses through each of the targets 440A-440C. In some examples, the system 120 and/or the system 110 determines that the distal portion 414 of the virtual instrument 412 successfully traversed the virtual passageway 440 when the distal portion 414 passes through and/or contacts each target 440A-440C, e.g., the outer rings and/or the nucleus of each virtual target 440A-440C. In some cases, the system 120 and/or the system 110 may determine that the distal portion 414 contacts a target 440A-440C when the contact is made within a contact threshold. The following discussion is made with respect to the target 440A and similarly applies to the targets 440B and 440C. In some examples, the contact may be made within the contact threshold when the distal portion 414 contacts the nucleus 444A of the target 440A. In other examples, the contact may be made within the contact threshold when the distal portion 414 contacts the target 440A just inside the outer rings 442A. In other examples, the contact may be made within the contact threshold when the distal portion 414 contacts the outer rings 442A.

In some embodiments, when the distal portion 414 passes through and/or contacts each target 440A-440C, an effect may be provided to indicate that the distal portion 414 passed through and/or contacted each target 440A-440C. For example, the display screen 112 may illustrate an effect (e.g., each target 440A-440C explodes, implodes, fades, disappears, etc.), an audio signal may be played, the display screen 112 may display a textual indicator, the targets 440A-440C may change color, the user may receive haptic feedback through the input control device 134, the input control device 136, and/or the housing 132 of the user control system 130, and/or any other similar indication may be presented. In some examples, the effect may change based on the contact between the distal portion 414 and the targets 440A-440C. For example, before the distal portion 414 contacts the outer rings 442A, the target 440A may be illustrated in a first display state, such as a solid color, fully opaque, etc. When the distal portion 414 first contacts the outer rings 442A, the target 440A may then be illustrated in a second display state, such as a gradient of color, partially opaque, etc. As the distal portion 414 moves closer to the nucleus 444A, the display state of the target 440A may continue to change. For example, the color of the target 440A may continue to change from the color of the first display state (e.g., red) to a second color (e.g., green). Additionally or alternatively, the opacity of the target 440A may continue to change from the opacity of the first display state (e.g., fully opaque) to a second opacity (e.g., fully translucent). When the system 120 and/or the system 110 determines that the distal portion 414 has successfully reached the target 440A—e.g., when the contact between the distal portion 414 and the target 440A is within the contact threshold discussed above—the display screen 112 may illustrate an effect (e.g., the target 440A explodes, implodes, fades, disappears, etc.). The above discussion similarly applies to the targets 440B and 440C.

As discussed above, the input control device 136 may control articulation of the virtual instrument 412. In some embodiments, when the user rolls the input control device 136 in a certain direction, the distal portion 414 of the virtual instrument 412 may bend in a corresponding direction. For example, the input control device 136 may be used to concurrently control both the pitch and yaw of the distal portion 414. In some examples, rotation of the input control device 136 in a forward direction (e.g., the direction D2) and a backward direction (e.g., the direction D4) may be used to control a pitch of the distal portion 414. Rotation of the input control device 136 in a left direction (e.g., a direction D6 (FIG. 1B)) and a right direction may be used to control a yaw of the distal portion 414. For example, when the user rolls the input control device 136 in the direction D6, the distal portion 414 may bend in a direction D7. In some examples, the user may control whether the direction of rotation is normal and/or inverted relative to the direction in which the distal portion 414 is moved (e.g., rotating forward to pitch down and backward to pitch up versus rotating backward to pitch down and forward to pitch up). For example, when the user rolls the input control device 136 in the direction D6, the distal portion 414 may bend in a direction D8. In some embodiments, the virtual passageway 440 is not aligned with the longitudinal axis of the virtual instrument 412. In such embodiments, the user may actuate both input control devices 134, 136 to navigate the virtual instrument 412 through the virtual passageway 440.

In some embodiments, the user may select Exercise 5 of the Introduction Module by selecting the exercise icon 260E. Exercise 5 of the Introduction Module may be a passageway navigation exercise. In some embodiments, a dynamic GUI 450 for the passageway navigation exercise may be shown on the display screen 112 when the user activates the passageway navigation exercise of the Introduction Module. The GUI 450 provides training for using the input control device 134 and the input control device 136 at the same time.

As seen in FIG. 3E, the display screen 112 displays the GUI 450 including a first portion 450A and a second portion 450B. In some embodiments, the first portion 450A illustrates a global perspective view of the virtual catheter 410, the virtual instrument 412, and a virtual passageway 460. In some examples, the second portion 450B illustrates a view from the distal tip of the virtual instrument 412. Both the first portion 450A and the second portion 450B may be updated in real time as the virtual instrument 412 traverses the virtual passageway 460.

In the passageway navigation exercise of GUI 450, the GUI 450 may provide training to teach the user to navigate the virtual instrument 412 through the virtual passageway 460. In some examples, the virtual passageway 460 is defined by a virtual tube 470. The virtual tube 470 includes a distal end 472 and defines a lumen 474. The user may complete the passageway navigation exercise by navigating the virtual instrument 412 through the lumen 474 to reach the distal end 472. In some examples, the system 120 and/or the system 110 determines the distal portion 414 of the virtual instrument 412 successfully traversed the virtual passageway 460 when the distal portion 414 passes through and/or contacts the distal end 472. The user may control the virtual instrument 412 in a substantially similar manner as discussed above with respect to FIG. 3C. For example, when the virtual instrument 412 reaches the distal end 472 of the virtual tube, the display screen 112 may illustrate an effect (e.g., the distal end 472 and/or any other part of the virtual tube 470 explodes, implodes, fades, disappears, etc.), an audio signal may be played, the display screen 112 may display a textual indicator, the virtual tube 470 may change color, the user may receive haptic feedback through the input control device 134, the input control device 136, and/or the housing 132 of the user control system 130, and/or any other similar indication may be presented.

FIG. 4 illustrates a set of instructions 500 for completing one or more exercises using any of the exercise GUI's 300, 350, 400, 430, 450. For example, the set of instructions 500 may be displayed on one or both of the display screens 112, 122 after the user selects an exercise icon but before the exercise is activated. In other examples, the set of instructions 500 may be displayed on one or both of the display screens 112, 122 before and/or while the exercise is activated. For example, the set of instructions 500 may be overlaid on the insertion/retraction exercise GUI 300 when the exercise GUI 300 is displayed on the display screen 112. In other examples, the set of instructions 500 may be displayed as a picture-in-picture with the exercise GUI 300 on the display screen 112. In further examples, the set of instructions 500 may be displayed adjacent to the exercise GUI 300, on the display screen 112, for example. In some embodiments, the individual instructions within the set of instructions 500 may be tailored to the particular exercise selected by the user. As shown in FIG. 4, the set of instructions 500 may provide suggestions to the user regarding how to efficiently control the virtual instrument. For example, the set of instructions 500 may suggest that the user use both hands when navigating the virtual instrument 412 through a virtual passageway (e.g., one or more of the virtual passageways 420, 440, 460). This may help train the user by familiarizing the user with the process of simultaneously actuating the input control devices 134, 136.

Additionally or alternatively, the set of instructions 500 may provide instructions to the user on how to interact with the GUI 200. For example, the set of instructions 500 may instruct the user on how to select one of the module icons 210A-210E and then how to select one of the exercise icons within the selected module. In some embodiments, the set of instructions 500 may provide a mix of instructions and goals for a particular module/exercise.

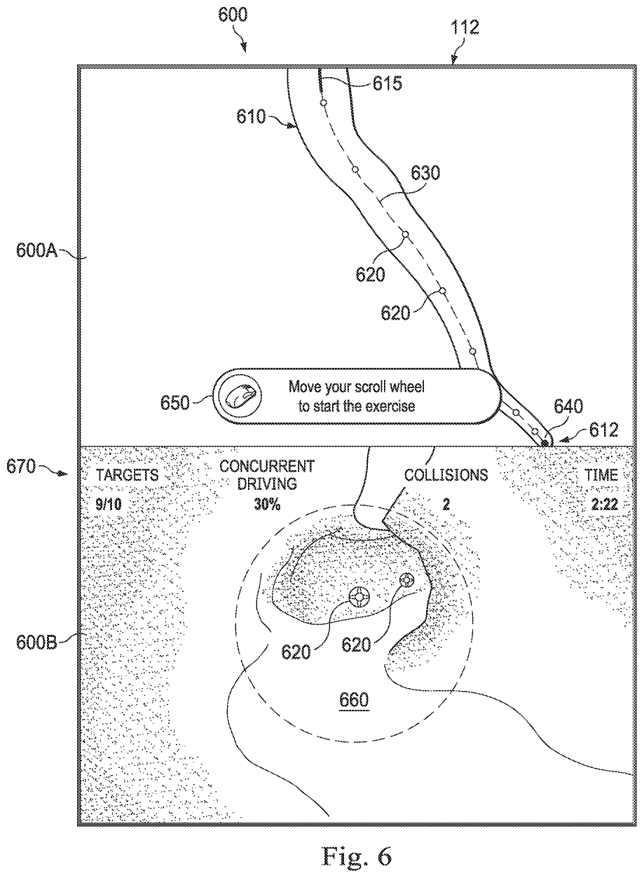

With reference to FIG. 6, in some embodiments, the display screen 112 illustrates a dynamic GUI 600 for a first exercise in the Basic Driving 1 Module. The GUI 600 may include a first portion 600A and a second portion 600B. The Basic Driving 1 Module may provide training for using the user control system 130 to navigate a virtual instrument through various virtual passageways of one or more shapes. For example, the user may actuate the input control devices 134, 136 to insert, retract, and/or steer a virtual instrument 615 through various virtual passageways. In some embodiments, the user may activate the Basic Driving 1 Module by selecting the module icon 210B on the display screen 122 using any one or more of the selection methods discussed above. After the module icon 210B is selected, the display screen 122 may then display a graphical user interface displaying the exercises that are included in the Basic Driving 1 Module. In some embodiments, the Basic Driving 1 Module includes five exercises, but any other number of exercises may be included within the Basic Driving 1 Module.

In some embodiments, the user may activate the first exercise in the Basic Driving 1 Module by selecting an exercise icon corresponding to the first exercise using any one or more of the selection methods discussed above. In some embodiments, the first portion 600A of the GUI 600 illustrates a global perspective view of a virtual passageway 610. In some examples, the second portion 600B illustrates a view from a distal tip of a virtual instrument 615. The virtual instrument 615 may be substantially similar to the virtual instrument 412. Both the first portion 600A and the second portion 600B may be updated in real time as the virtual instrument 615 traverses the virtual passageway 610.

As seen in FIG. 6, the virtual passageway 610 includes a plurality of virtual targets 620 positioned within the virtual passageway 610. The virtual passageway 610 further includes a virtual final target 640 located within a distal portion 612 of the virtual passageway 610. When performing the exercise using the GUI 600, the user may use the input control devices 134, 136 to navigate the virtual instrument 615 through the virtual passageway 610 while hitting each of the targets 620, 640. In some examples, the user may use the input control devices 134, 136 to navigate the virtual instrument 615 through the virtual passageway 610 and hit each of the targets 620, 640 while maintaining the virtual instrument 615 as close as possible to a path 630. The path 630 may be defined by the targets 620. In some embodiments, the path 630 may represent the optimal traversal path the virtual instrument 615 should take through the virtual passageway 610. The path 630 may be determined based on parameters such as amount of contact between the virtual instrument 615 and the walls of the virtual passageway 610 or such as the amount of time the virtual instrument 615 takes to traverse the length of the virtual passageway 610. For example, the path 630 may be determined by optimizing or minimizing such parameters. In some examples, the path 630 may be substantially aligned with a longitudinal axis of the virtual passageway 610. In other examples, such as when the virtual passageway 610 is a more complex shape, the path 630 may not be aligned with the longitudinal axis of the virtual passageway 610. In such examples, the virtual instrument 615 may need to take a wider angle of approach than the angle of approach following the longitudinal axis of the virtual passageway 610 to reduce and/or avoid contact between the virtual instrument 615 and the wall of the virtual passageway 610.

As further shown in FIG. 6, the display screen 112 may display instructions 650. While the instructions 650 are shown at the bottom of the first portion 600A, the instructions 650 may be shown at any suitable location on the display screen 112 (e.g., at a top of the display screen 112, at a side of the display screen 112, at a bottom of the display screen 112, or at any other location that may or may not be along an edge of the display screen 112). In some embodiments, the instructions 650 may change depending on how far the user has progressed through the exercise using GUI 600. For example, the instructions 650 may guide the user to move the input control device 134 to start the exercise. In some examples, after the exercise is started, the instructions 650 may change to instruct the user to control the virtual instrument 615 so that the virtual instrument 615 contacts each target 620. Additionally or alternatively, the instructions 650 may instruct the user to maintain the virtual instrument 615 along the path 630. In some embodiments, when the user completes the exercise, the instructions 650 may tell the user to return to the GUI 250 to select another exercise and/or to return to the GUI 200 to select another module. Additionally or alternatively, any one or more of the above instructions or any additional instructions may be displayed on the display screen 122.

In several embodiments, the first portion 600A may illustrate the virtual instrument 615 advancing through the virtual passageway 610 in real time. In some embodiments, an indicator may be displayed on the display screen 112 to indicate the proximity of the path of the virtual instrument 615 to the path 630. For example, if the path of the virtual instrument 615 is substantially aligned with the path 630, the virtual instrument 615 may be illustrated as a green color, indicating a satisfactory proximity of the virtual instrument 615 to the path 630. If the path of the virtual instrument 615 deviates from the path 630, the virtual instrument 615 may be illustrated as a red color, indicating an unsatisfactory proximity of the virtual instrument 615 to the path 630. The proximity of the path of the virtual instrument 615 to the path 630 may be illustrated in any other suitable manner (e.g., a textual indicator, audible indicator, haptic feedback, etc.). In some embodiments, after the virtual instrument 615 contacts a target 620, the target 620 may no longer be displayed on the display screen 112. Additionally or alternatively, after the virtual instrument 615 contacts a target 620, an effect may be illustrated (e.g., the target 620 explodes, implodes, fades, disappears, etc.), the user may receive haptic feedback, and/or any other similar effect may be presented.

As discussed above, the second portion 600B of the GUI 600 illustrates a view from the perspective of the distal tip of the virtual instrument 615. In some examples, the second portion 600B illustrates a lumen 660 of the virtual passageway 610. The targets 620 may also be displayed within the lumen 660. As the virtual instrument 615 is inserted further into the virtual passageway 610 and approaches each target 620, each target 620 increases in size as the distal tip of the virtual instrument 615 gets closer to each target 620. When the virtual instrument 615 contacts a target 620, an effect may be illustrated on the display screen 112 (e.g., the target 620 explodes, implodes, fades, disappears, etc.), the user may receive haptic feedback, and/or any other similar contact-indicating effect may be presented.

In some embodiments, the display screen 112 may display a plurality of performance metrics 670 over the second portion 600B. Each performance metric in the plurality of performance metrics 670 may be updated in real time as the virtual instrument 615 navigates through the virtual passageway 610. The performance metrics 670 may track the user's performance as the user controls the virtual instrument 615, which will be discussed in greater detail below.

In several examples, the virtual passageway 610 may be a virtual anatomical passageway. In some embodiments, the virtual anatomical passageway 610 may be generated by one or both of the computing systems 110, 120. In other embodiments, the virtual anatomical passageway 610 may represent an actual anatomical passageway in a patient anatomy. For example, the virtual anatomical passageway 610 may be generated from CT data, Mill data, fluoroscopy data, etc., that may have been generated prior to, during, or after a medical procedure.

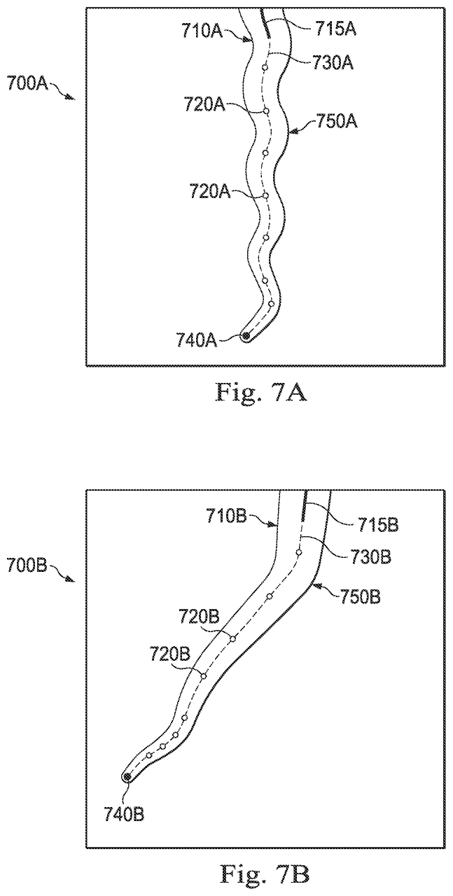

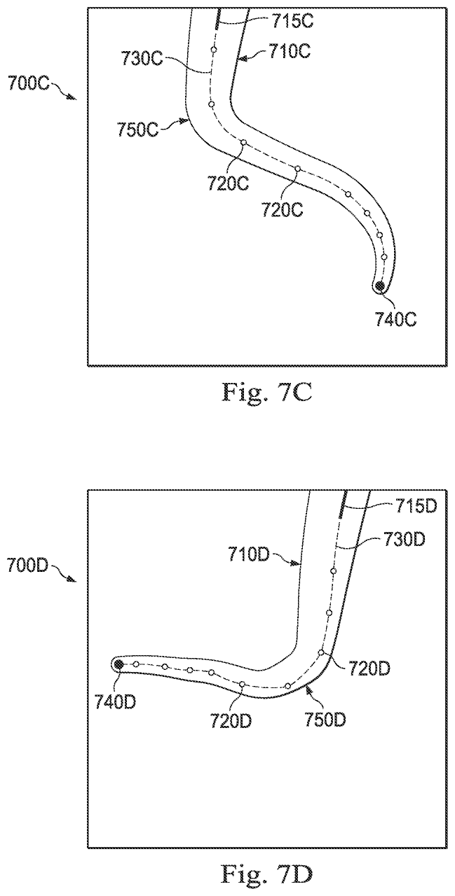

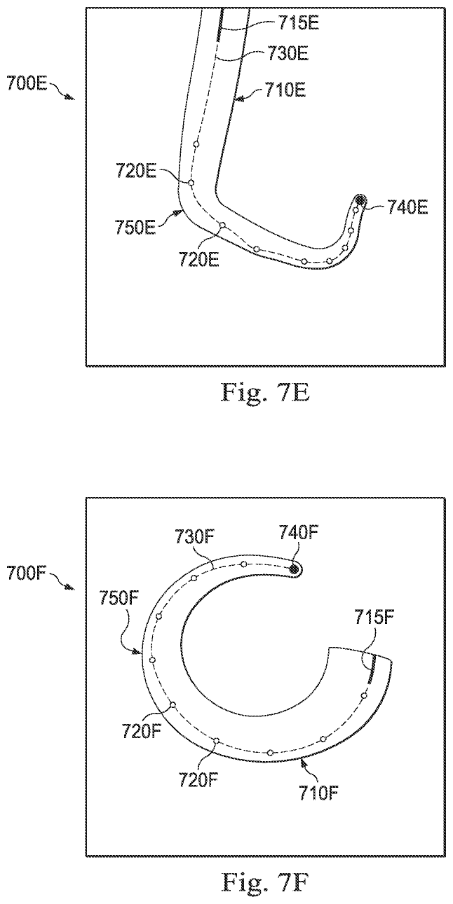

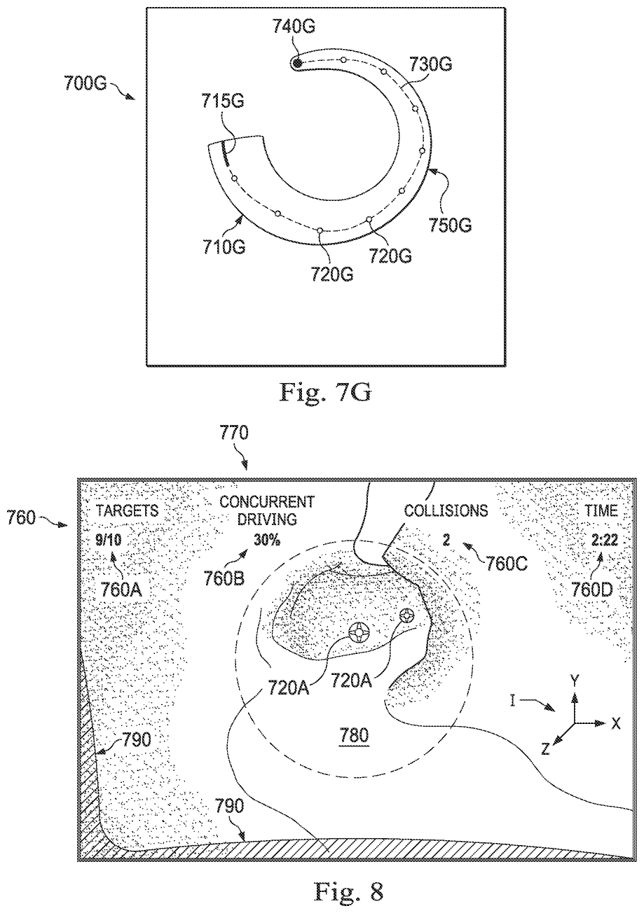

As discussed above, the Basic Driving 1 Module may include five exercises. The Basic Driving 2 Module may include three exercises in some embodiments, but may include any other number of exercises in other embodiments. With reference to FIGS. 7A-7G, a dynamic GUI 700A-700G for some exercises of the Basic Driving 1 and Basic Driving 2 Modules may be displayed on the display screen 112. Each exercise GUI 700A-700G may introduce the user to a virtual environment in which to practice operation of the user control system 130. Each GUI 700A-700G may be displayed in place of the first portion 600A of the GUI 600. In some embodiments, the GUIs 700A-700E may be displayed for the exercises included in the Basic Driving 1 Module, and the GUIs 700F and 700G may be displayed for the exercises included in the Basic Driving 2 Module. The exercises may be split between these two modules in any other suitable manner. In other embodiments, the exercises may all be included in one module. The GUIs 700A-700G include various virtual passageways 710A-710G, respectively. In each exercise, the user may navigate a virtual instrument 715A-715G through a corresponding one of the virtual passageways 710A-710G. In some examples, one or more of the virtual passageways 710A-710G may be based on one or more anatomical passageways of a patient anatomy. For example, one or more centerline points of the virtual passageway 710A may correspond to one or more centerline points of an anatomical passageway of the patient anatomy. Similarly, one or more centerline points of each of the virtual passageways 710B-710G may correspond to one or more centerline points of one or more anatomical passageways of the patient anatomy.

In some examples, the GUI 700A may be displayed for Exercise 1 of the Basic Driving 1 Module, the GUI 700B may be displayed for Exercise 2 of the Basic Driving 1 Module, the GUI 700C may be displayed for Exercise 3 of the Basic Driving 1 Module, the GUI 700D may be displayed for Exercise 4 of the Basic Driving 1 Module, the GUI 700E may be displayed for Exercise 5 of the Basic Driving 1 Module, the GUI 700F may be displayed for Exercise 1 of the Basic Driving 2 Module, and the displayed for 700G may be displayed for Exercise 2 of the Basic Driving 2 Module. In other examples, the GUIs 700A-700G may be displayed for exercises included in any other module(s). Other exercises may be included in one or more of the modules discussed above or in any additional modules that may be included within the computing systems 110, 120.

With reference to FIG. 7A, the exercise GUI 700A illustrates the virtual passageway 710A, a plurality of virtual targets 720A, a path 730A, and a virtual final target 740A. The virtual targets 720A may be substantially similar to the virtual targets 620, and the virtual final target 740A may be substantially similar to the virtual final target 640. In some embodiments, the path 730A may represent the optimal path a virtual instrument (e.g., the virtual instrument 615) may take through the virtual passageway 710A. The optimal path may be determined by the processing system 116 and/or the processing system 126, by the user during a set-up stage, or by the processing systems 116/126 and altered by the user during the set-up stage. The processor or user may define the optimal path by determining the shortest path through the virtual passageway 710A, by determining a path that would minimize the degree of bending in the virtual instrument 715A to ensure the degree of bending is lower than a threshold degree of bending, and/or by determining a path that would position the virtual instrument 715A in an optimal pose (e.g., position and orientation) relative to an anatomical target at the end of the path. In some examples, the user may navigate the virtual instrument 715A through the virtual passageway 710A.

In some examples, each virtual passageway 710A-710G may represent a progressively more complex virtual passageway. For example, the virtual passageway 710B may be more complex than the virtual passageway 710A by including, for example, at least one sharper bend/curve, at least one portion with a narrower passageway width, more bends/curves, etc. In some examples, the virtual passageway 710G may be the most complex shape of the virtual passageways 710A-710G. In such examples, the virtual passageway 710G may be more complex than the virtual passageway 710F, which may be more complex than the virtual passageway 710E, which may be more complex than the virtual passageway 710D, which may be more complex than the virtual passageway 710C, which may be more complex than the virtual passageway 710B, which may be more complex than the virtual passageway 710A. In other examples, any of the virtual passageways 710A-710G may be any degree of complexity, and there may be a random order to the degree of complexity of the virtual passageways 710A-710G.

In some examples, the virtual passageway 710A may include at least one bend 750A, which may be an S-curve, through which the virtual instrument 715A must navigate to reach the target 740A. The exercise GUI 700A may be used to train the user to use the user control system 130 to navigate a virtual instrument through a virtual passageway, such as the virtual passageway 710A, that includes one or more minor bends (e.g., bends less than 45°). Thus, the exercise GUI 700A may provide training to the user with respect to navigating a non-linear virtual passageway.

FIG. 7B illustrates the exercise GUI 700B, which includes the virtual passageway 710B. The virtual passageway 710B may include at least one bend 750B that is generally 45° through which the virtual instrument 715B must navigate to reach the target 740B. The exercise GUI 700B may be used to train the user to use the user control system 130 to navigate a virtual instrument through a virtual passageway, such as the virtual passageway 710B, that includes at least one 45° bend. Thus, the exercise GUI 700B may provide training to the user with respect to navigating a non-linear virtual passageway of a more complex shape than a virtual passageway with only minor bends.

FIG. 7C illustrates the exercise GUI 700C, which includes the virtual passageway 710C. The virtual passageway 710C may include at least one bend 750C that is generally 90° through which the virtual instrument 715C must navigate to reach the target 740C. FIG. 7D illustrates the exercise GUI 700D, which includes the virtual passageway 710D. The virtual passageway 710D may include at least one bend 750D that is generally 90° through which the virtual instrument 715D must navigate to reach the target 740D. FIG. 7E illustrates the exercise GUI 700E, which includes the virtual passageway 710E. The virtual passageway 710E may include at least one bend 750E that is generally 90° through which the virtual instrument 715E must navigate to reach the target 740E. The exercise GUIs 700C-700E may each be used to train the user to use the user control system 130 to navigate a virtual instrument through a virtual passageway that includes at least one 90° bend. Thus, the exercise GUIs 700C-700E may provide training to the user with respect to navigating a non-linear virtual passageway of a more complex shape than a virtual passageway with only 45° bends. Additionally, the bends may occur in any direction, which may help train to the user to navigate virtual passageways of varying orientations.

FIG. 7F illustrates the exercise GUI 700F, which includes the virtual passageway 710F. The virtual passageway 710F may include at least one bend 750F that is generally 180° through which the virtual instrument 715F must navigate to reach the target 740F. FIG. 7G illustrates the exercise GUI 700G, which includes the virtual passageway 710G. The virtual passageway 710G may include at least one bend 750G that is generally 180° through which the virtual instrument 715G must navigate to reach the target 740G. The exercise GUIs 700F and 700G may each be used to train the user to use the user control system 130 to navigate a virtual instrument through a virtual passageway that includes at least one 180° bend. Thus, the exercise GUIs 700F and 700G provide training to the user with respect to navigating a non-linear virtual passageway of a more complex shape than a virtual passageway with only 90° bends. Additionally, the bends may occur in any direction, which helps train to the user to navigate virtual passageways of varying orientations. Furthermore, the exercise GUIs 700F and 700G may help train the user to navigate the virtual instrument through a virtual passageway that includes a constant bend without any linear sections of the virtual passageway.

Any one or more of the virtual passageways 710A-710G may include any one or more of the features discussed above and/or may include additional features not discussed above (e.g., generally straight passageways, passageways with different bends and/or different combinations of bends, etc.).

The discussion above with respect to the virtual passageway 610 may apply to each of the virtual passageways 710A-710G. For example, with respect to the virtual passageway 710A, the path 730A may represent the optimal path the virtual instrument 615 should take through the virtual passageway 710A. Additionally, the discussion above with respect to FIG. 6 may similarly apply to any other like features between FIG. 6 and FIGS. 7A-7G.

FIG. 8 illustrates a portion 770 of a dynamic GUI (e.g., GUI 700A, 600) that may be displayed on the display screen 112. In some embodiments, the portion 770 may be displayed on the display screen 112 in place of the second portion 600B of the dynamic GUI 600. As discussed above, the second portion 600B illustrates a view from the distal tip of the virtual instrument 615. Similarly, the portion 770 illustrates a view from the distal tip of the virtual instrument 715A. In some examples, the portion 770 illustrates a lumen 780 of the virtual passageway 710A. The portion 770 further includes the targets 720A, which may be displayed within the lumen 780. As the virtual instrument 715A is inserted further into the virtual passageway 710A and approaches each target 720A, each target 720A increases in size as the distal tip of the virtual instrument 715A gets closer to each target 720A. When the virtual instrument 715A contacts a target 720A, an effect may be illustrated on the display screen 112 (e.g., the target 720A explodes, implodes, fades, disappears, etc.), the user may receive haptic feedback, and/or any other similar contact-indicating effect may be presented.

In some embodiments, the display screen 112 may display a plurality of performance metrics 760 in the portion 770 of the exercise GUI 700A. Each performance metric 760A-760D in the plurality of performance metrics 760 may be updated in real time as the virtual instrument 715A navigates through a virtual passageway (e.g., virtual passageway 710A). The performance metrics 760 may track the user's performance as the user controls the virtual instrument 615. In some embodiments, the performance metrics track the user's ability to navigate through and stay within virtual passageways and hit virtual targets. In other embodiments, the performance metrics track the user's ability or efficiency to follow optimal paths or position the virtual instrument in an optimal final position/orientation. In other embodiments, the performance metrics track the user's proficiency in using various input devices during navigation and driving. In some embodiments, the performance metrics track any combination of types of metrics corresponding to driving within passageways/along targets, driving along optimal paths/positions, and proficiency using user input devices.

The following discussion regarding the performance metrics will be made with reference to FIG. 7A. The discussion similarly applies to the virtual instruments, virtual passageways, etc., in any one or more of FIGS. 3A-3E, 6, 7B-7G, 8, 9A, 9B, and 11.

In some examples, performance metrics corresponding with measuring the user's ability to navigate through and stay within virtual passageways and hit virtual targets can be tracked and displayed or used to provide a score indicating user driving ability within a passageway. In some embodiments, the plurality of performance metrics 760 may include one or more of a “targets” metric 760A, a “concurrent driving” metric 760B, a “collisions” metric 760C, and a “time to complete” metric 760D. The plurality of performance metrics 760 may further include one or more additional metrics, such as a “centered driving” metric, a “missed target, reverse, then hit target” metric, a “force measurement” metric, a “tenting angle” metric, a “tap collision” metric, a “dragging collision” metric, an “instrument deformation” metric, a “bend radius” metric, or the like. Any one or more of these metrics (or any other metrics not listed) may be displayed on the display screen 112 and/or the display screen 122. Additionally or alternatively, any one or more of these metrics (or any other metrics not listed) may be tracked by the computing system 110 and/or the computing system 120, regardless of whether the metrics are displayed on the display screen 112 and/or the display screen 122. In some examples, the plurality of performance metrics 760 are not displayed on the display screen 112 while the user is performing an exercise. In such examples, the performance metrics 760 may be displayed when the user completes the exercise, which will be discussed in greater detail below.

In some examples, the “targets” metric 760A tracks the number of targets (e.g., the targets 720A) hit by the virtual instrument 715A out of the total number of targets within the virtual passageway 710A as the virtual instrument 715A traverses the virtual passageway 710A. The number of targets hit may be updated in real time. For example, when the virtual instrument 715A contacts one of the targets 720A, the “targets” metric 760A may increase by an increment of “one.” In some cases, when the virtual instrument 715A contacts the first target 720A, the “targets” metric 760A may change from “0/10” to “1/10.” In several embodiments, the “targets” metric 760A may be tracked for one or more exercises in one or more of the Basic Driving 1 Module and the Basic Driving 2 Module.

In some examples, the “collisions” metric 760C tracks the number of times the distal tip of the virtual instrument 715A collides with a wall of the virtual passageway 710A. For example, each time the distal tip contacts the wall of the virtual passageway 710A, the “collisions” metric 760C may increment its counter by one unit (e.g., from 1 to 2). In some embodiments, the contact force (which may be a collision force) between the virtual instrument 715A and the wall of the virtual passageway 710A may need to reach a threshold force (e.g., a threshold collision force) to constitute a “collision” for purposes of incrementing the “collisions” metric 760C. In other embodiments, a collision of any contact force may result in the “collisions” metric 760C incrementing its counter. In some embodiments, the threshold force may be the force required to move the distal tip of the virtual instrument 715A two (2) millimeters past the wall of the virtual passageway 710A. The threshold force may be the force required to move the distal tip of the virtual instrument 715A any other distance (e.g., 1 mm, 3 mm, 4 mm, etc.) past the wall of the virtual passageway 710A.

In some embodiments, a virtual tip (not shown) may surround the distal tip of the virtual instrument 715A. The virtual tip may be a sphere, a half-sphere, a cube, a half-cube, or the like. A “collision” may occur when the virtual tip contacts (e.g., touches, overlaps with, etc.) the wall of the virtual passageway 710A. In some examples, the virtual tip may contact the wall when an amount of overlap between the virtual tip and the wall exceeds a threshold amount of overlap. The threshold amount of overlap may be 0.25 mm, 0.5 mm, or any other distance. In such examples, the “collisions” metric may increment its counter when the amount of overlap exceeds the threshold amount of overlap. In some cases, this may occur before the distal tip of the virtual instrument 715A contacts the wall of the virtual passageway 710A. The user's goal may be to minimize the amount of collisions that occur between the virtual instrument 715A and the wall of the virtual passageway 710A. In several embodiments, the “collisions” metric 760C may be tracked for one or more exercises in one or more of the Basic Driving 1 Module, the Basic Driving 2 Module, the Airway Driving 1 Module, and the Airway Driving 2 Module.

In some examples, the “time to complete” metric 760D tracks the total time elapsed from when the virtual instrument 715A first starts moving to when the virtual instrument 715A contacts the target 740A. The user's goal may be to minimize the total amount time it takes to complete the exercise (e.g., the exercise shown in the GUI 700A). In several embodiments, the “time to complete” metric 760D may be tracked for one or more exercises in one or more of the Basic Driving 1 Module, the Basic Driving 2 Module, the Airway Driving 1 Module, and the Airway Driving 2 Module. In alternative embodiments, the “time to complete” metric 760D is only tracked when one or both of the input control devices 134, 136 is being actuated. For example, if the user stops actuating one or both of the input control devices 134, 136 and walks away from the user control system 130 in the middle of performing the exercise, a timer calculating the “time to complete” may pause. The timer may start again when the user returns to the user control system 130 and resumes actuating one or both of the input control devices 134, 136.

In some embodiments, the “centered driving” metric tracks the percentage of time the distal tip of the virtual instrument 715A is in the center of the virtual passageway 710A. For example, the “centered driving” metric compares the amount of time the distal tip of the virtual instrument 715A is in the center of the virtual passageway 710A to the total amount of time the virtual instrument 715A is moving through the virtual passageway 710A. In some cases, the “centered driving” metric tracks the percentage of time the distal tip of the virtual instrument 715A is in the center of the virtual passageway 710A when the virtual instrument 715A is traversing one or more straight sections of the virtual passageway 710A. In some embodiments, the virtual passageway 710A includes more than one straight section. In such embodiments, the “centered driving” metric may separately track the percentage of time the distal tip of the virtual instrument 715A is in the center of each straight section of the virtual passageway 710A. For example, the “centered driving” metric may determine a percentage for a first straight section, a percentage for a second straight section, a percentage for a third straight section, etc. Additionally or alternatively, the “centered driving” metric may track the total percentage of time the distal tip of the virtual instrument 715A is in the center of all the straight sections of the virtual passageway 710A combined. In further alternative embodiments, the “centered driving” metric may separately track the percentage of time the distal tip of the virtual instrument 715A is in the center of one or some of the straight sections of the virtual passageway 710A, but not all of the straight sections. The user's goal may be to maximize the percentage of time the distal tip of the virtual instrument 715A is in the center of the virtual passageway 710A.

In some embodiments, the “missed target, reverse, then hit target” metric tracks the number of times the virtual instrument 715A misses/passes a target (e.g., one or more of the targets 720A), is retracted back past the target, and then is inserted again and hits the target. The number of times the virtual instrument 715A misses a target, reverses, and then hits the target may be updated in real time. For example, when the virtual instrument 715A misses a target, reverses, and then hits the target, the “missed target, reverse, then hit target” metric may increase by an increment of “one.” In some cases, when the virtual instrument 715A misses a target, reverses, and then hits the target, the “missed target, reverse, then hit target” metric may change from “0” to “1.” In some examples, the “missed target, reverse, then hit target” metric may track the distance traveled and the time elapsed when the virtual instrument 715A reverses and tries to hit the target again. The user's goal may be to minimize the number of missed targets.

In some embodiments, the “force measurement” metric tracks an amount of force applied by the distal tip of the virtual instrument 715A to the wall of the virtual passageway 710A when the distal tip of the virtual instrument 715A contacts the wall of the virtual passageway 710A. The system 110 and/or the system 120 may calculate the force based on a detected deformation of the wall of the virtual passageway 710A, an angle of approach of the distal tip of the virtual instrument 715A relative to the wall of the virtual passageway 710A, and/or a stiffness of the virtual instrument 715A. The goal may be to minimize the amount of force applied to the wall and, if force is applied to the wall, to minimize the length of time the force is applied to the wall. In some embodiments, the deformation of the virtual passageway 710A may be determined based on the relative positions of the distal tip of the virtual instrument 715A and the wall of the virtual passageway 710A. In some embodiments, the stiffness of the virtual instrument 715A may be a predetermined amount that is provided to the system 110 and/or the system 120. The stiffness may be provided before an exercise (e.g., the exercise shown in the GUI 700A) is activated and/or while the exercise is activated. The goal may be to minimize the amount of deformation of the virtual passageway 710A and, if the virtual passageway 710A is deformed, to minimize the length of time the virtual passageway 710A is deformed.

Additionally or alternatively, the “force measurement” metric may track an amount of force applied by the distal tip of the virtual instrument 715A to a gamified exercise wall when the distal tip of the virtual instrument 715A contacts the gamified exercise wall. In some examples, the gamified exercise wall represents the wall of the virtual passageway 710A. The system 110 and/or the system 120 may calculate this force to increase the accuracy with which the interaction between the virtual instrument 715A and the wall of the virtual passageway 710A is displayed (e.g., on the display screen 112 and/or on the display screen 122).

In some embodiments, the “tenting angle” metric measures a contact angle—the angle at which the distal tip of the virtual instrument 715A contacts the wall of the virtual passageway 710A. When the distal tip of the virtual instrument 715A contacts the wall of the virtual passageway 710A, the wall will “tent” (e.g., expand at least in a radial direction). The contact angle may define an amount of tenting. In some examples, the contact angle is shallow (e.g., less than 30° from the wall of the virtual passageway 710A). In other examples, the contact angle is steep (e.g., greater than or equal to 30° from the wall of the virtual passageway 710A). The amount of tenting of the wall may be greater when the contact angle is steep than when the contact angle is shallow. The user's goal may be to minimize the contact angle.

In some embodiments, the “tap collision” metric tracks the number of times the distal tip of the virtual instrument 715A taps a wall of the virtual passageway 710A. The tap may be a minor bounce off the wall. For example, each time the distal tip taps the wall of the virtual passageway 710A, the “tap collision” metric may increment its counter by one unit (e.g., from 0 to 1). In some embodiments, if the contact force (which may be a collision force) between the virtual instrument 715A and the wall of the virtual passageway 710A is equal to or below a threshold force (e.g., the threshold collision force discussed above with respect to the “collisions” metric 760C), then the contact constitutes a “tap” for purposes of incrementing the “tap collision” metric. If the contact force is above the threshold force, then the contact constitutes a collision. The user's goal may be to minimize the number of taps that occur between the virtual instrument 715A and the wall of the virtual passageway 710A.

In some embodiments, the “dragging collision” metric tracks the amount of time the virtual instrument 715A is moving (either forward or backward) while contacting the wall of the virtual passageway 710A. In some examples, the system 110 and/or the system 120 starts the timer of the “dragging collision” metric when the virtual instrument 715A is moving and the distal tip of the virtual instrument 715A is in contact with the wall of the virtual passageway 710A. Additionally or alternatively, the system 110 and/or the system 120 starts the timer when the virtual instrument 715A is moving and any portion of the virtual instrument 715A is in contact with the wall. In some cases, the “dragging collision” metric may track a distance the virtual instrument 715A is moving while contacting the wall of the virtual passageway 710A. The user's goal may be to minimize the amount of time and/or the distance the virtual instrument 715A is moving while contacting the wall of the virtual passageway 710A.

In some embodiments, the “instrument deformation” metric tracks whether the virtual instrument 715A becomes deformed while traversing the virtual passageway 710A. For example, the “instrument deformation” metric may track whether the distal tip of the virtual instrument 715A and/or the shaft of the virtual instrument 715A experiences wedging. Wedging may occur when the distal tip and/or the shaft of the virtual instrument 715A gets stuck (e.g., pinned, pressed, etc.) against the wall of the virtual passageway 710A. The wedged portion of the virtual instrument 715A may no longer be able to move in an insertion direction through the virtual passageway 710A. A display screen (e.g., the display screen 112 and/or the display screen 122) may illustrate whether the virtual instrument 715A is wedged against the wall of the virtual passageway 710A. For example, the user may be able to look at the display screen and see that the virtual instrument 715A is wedged. Additionally or alternatively, a wedge indicator may be presented when the virtual instrument 715A is wedged. The wedge indicator may be a textual indicator, an audible indicator, a haptic indicator, any other indicator, or any combination thereof. Additionally or alternatively, the number of times the virtual instrument 715A is wedged may be updated in real time. For example, when the virtual instrument 715A is wedged, the “instrument deformation” metric may increase by an increment of “one,” such as from “0” to “1.”

In additional examples, the “instrument deformation” metric tracks whether the virtual instrument 715A experiences buckling. In some cases, buckling may occur when a portion of the virtual instrument 715A becomes wedged and the virtual instrument 715A continues to be inserted into the virtual passageway 710A. In such cases, a portion of the virtual instrument 715A may buckle. Additionally or alternatively, the wedged portion of the virtual instrument 715A may buckle. The display screen 112 and/or the display screen 122 may illustrate whether the virtual instrument 715A has buckled. For example, the user may be able to look at the display screen and see that the virtual instrument 715A has buckled. Additionally or alternatively, a buckling indicator may be presented when the virtual instrument 715A buckles. The buckling indicator may be a textual indicator, an audible indicator, a haptic indicator, any other indicator, or any combination thereof. Additionally or alternatively, the number of times the virtual instrument 715A buckles may be updated in real time. For example, when the virtual instrument 715A buckles, the “instrument deformation” metric may increase by an increment of “one,” such as from “0” to “1.”

In some embodiments, the performance metrics track the user's ability or efficiency to follow optimal paths or position the virtual instrument in an optimal final position/orientation. The optimal path may be determined by the processing system 116 and/or the processing system 126, by the user during a set-up stage, or by the processing systems 116/126 and altered by the user during the set-up stage. The processor or user may define the optimal path by determining the shortest path through the virtual passageway 710A, by determining a path that would minimize the degree of bending in the virtual instrument 715A to ensure the degree of bending is lower than a threshold degree of bending, and/or by determining a path that would position the virtual instrument 715A in an optimal pose (e.g., position and orientation) relative to an anatomical target at the end of the path. In some examples, the user may navigate the virtual instrument 715A through the virtual passageway 710A.

The plurality of performance metrics 760 may include one or more metrics, such as an “instrument positioning” metric, a “path deviation” metric, a “driving efficiency” metric, a “parking location” metric, a “bend radius” metric, or the like. Any one or more of these metrics (or any other metrics not listed) may be displayed on the display screen 112 and/or the display screen 122. Additionally or alternatively, any one or more of these metrics (or any other metrics not listed) may be tracked by the computing system 110 and/or the computing system 120, regardless of whether the metrics are displayed on the display screen 112 and/or the display screen 122. In some examples, the plurality of performance metrics 760 are not displayed on the display screen 112 while the user is performing an exercise. In such examples, the performance metrics 760 may be displayed when the user completes the exercise, which will be discussed in greater detail below.

In some embodiments, the “instrument positioning” metric tracks the number of times the virtual instrument 715A is optimally positioned in preparation for turning through a curved section (e.g., the curved section 750A) of the virtual passageway 710A. In some examples, if the virtual instrument 715A approaches a curved section at too shallow of an angle, the virtual instrument 715A will not be able to smoothly traverse through the curved section (e.g., without needing to be retracted and/or repositioned). Instead, the virtual instrument 715A will need to be iteratively repositioned (e.g., via sequences of short insertions and retractions) as the virtual instrument 715A traverses the curved section. The number of times the virtual instrument 715A is optimally positioned in preparation for turning through a curved section may be updated in real time. For example, when the virtual instrument 715A is optimally positioned, the “instrument positioning” metric may increase by an increment of “one.” In some cases, the virtual passageway 710A may include two curved portions. In such cases, when the virtual instrument 715A is optimally positioned, the “instrument position” metric may change from “0/2” to “1/2.” The virtual passageway 710A may include any other number of curved portions.

In some embodiments, the “path deviation” metric compares the traversal path of the virtual instrument 715A to the path 730A to see how closely the virtual instrument 715A followed the path 730A. In some examples, during and/or after an exercise is completed, the display screen 112 and/or the display screen 122 may display the virtual passageway 710A including both the traversal path of the virtual instrument 715A and the path 730A. This allows the system 110 and/or the system 120 to compare the traversal path of the virtual instrument 715A with the path 730A. In some examples, the path 730A is displayed while the user is performing the exercise. This allows the traversal path of the virtual instrument 715A to be compared with the path 730A in real time. In other examples, the path 730A is displayed only after the exercise is completed. This allows the traversal path of the virtual instrument 715A to be compared with the path 730A after the exercise is completed. In some examples, the system 110 and/or the system 120 may determine that the traversal path of the virtual instrument 715A deviates from the path 730A when the traversal path differs from the path 730A by a distance greater than a threshold distance, which may be 0.25 mm, 0.5 mm, 1 mm, etc. The user's goal may be to maximize the time and/or length that the traversal path of the virtual instrument 715A matches the path 730A.

In some embodiments, the “driving efficiency” metric tracks a length of the traversal path of the virtual instrument 715A to determine how efficiently the virtual instrument 715A traversed the virtual passageway 710A to reach the target 740A. This allows the system 110 and/or the system 120 to compare the length of the traversal path of the virtual instrument 715A with a length of the path 730A. In some examples, the “driving efficiency” metric may be presented as a ratio comparing the length of the traversal path of the virtual instrument 715A to the length of the path 730A. For example, a ratio of “2:1” may illustrate that the length of the traversal path of the virtual instrument 715A is twice as long as the length of the path 730A. Additionally or alternatively, the “driving efficiency” metric may illustrate a percentage by which the length of the traversal path of the virtual instrument 715A is longer than the length of the path 730A.

In some cases, the “driving efficiency” metric may track the number of times the virtual instrument 715A deviates from the path 730A. The number of times the virtual instrument 715A deviates from the path 730A may be updated in real time. For example, when the virtual instrument 715A deviates from the path 730A, the “driving efficiency” metric may increase by an increment of “one,” such as from “0” to “1.”

Additionally or alternatively, the “driving efficiency” metric may track the amount of time the virtual instrument 715A is moving (either forward or backward) while deviating from the path 730A. In some examples, the system 110 and/or the system 120 starts the timer of the “driving efficiency” metric when the virtual instrument 715A is moving and the distal tip of the virtual instrument 715A deviates from the path 730A. In other examples, the system 110 and/or the system 120 starts the timer when the virtual instrument 715A is moving and any portion of the virtual instrument 715A deviates from the path 730A.

In some embodiments, the “parking location” metric tracks the number of times the virtual instrument 715A reaches a target parking location. The target parking location may represent the optimal position and/or orientation of the virtual instrument 715A to allow the virtual instrument 715A to access a lesion or other target anatomy. In some examples, the target parking location may be the target 740A. In other examples, the target parking location may be represented by a clear marker positioned within the virtual passageway 710A. Additionally or alternatively, the target parking location may not be visible on the display screen 112, for example, but may be known by the system 110 and/or the system 120. In such cases, the system 110 and/or the system 120 may determine whether the parking location of the distal tip of the virtual instrument 715A reaches the “invisible” target parking location.

The number of times the virtual instrument 715A reaches the target parking location may be updated in real time. For example, when the virtual instrument 715A reaches the target parking location, the “parking location” metric may increase by an increment of “one.” In some cases, when the virtual instrument 715A reaches the target parking location, the “parking location” metric may change from “0/2” to “1/2.” The virtual passageway 710A may include any number of optimal parking locations (e.g., more or less than two optimal parking locations). In some embodiments, there may be more than one optimal parking location for one target anatomy. In other embodiments, there may be one optimal parking location per target anatomy. In still other embodiments, one parking location may be the optimal parking location for multiple targets.

The target parking location may be determined by the processing system 116 and/or the processing system 126 by determining a location that would minimize the degree of bending in the virtual instrument 715A to ensure the degree of bending is lower than a threshold degree of bending. Additionally or alternatively, the target parking location may be determined by the processing system 116 and/or the processing system 126 by determining a location that would place the virtual instrument 715A in an optimal position relative to an anatomical target. Additionally or alternatively, the target parking location may be determined by the processing system 116 and/or the processing system 126 by determining a location that would place the virtual instrument 715A in an optimal pose (e.g., position and orientation) relative to the anatomical target. In some examples, the target parking location may be determined by the processing system 116 and/or the processing system 126 by determining a location that would place the virtual instrument 715A in an optimal shape relative to the anatomical target.

In some embodiments, the “bend radius” metric tracks how many degrees the distal tip of the virtual instrument 715A is bent when the distal tip is articulated. The number of degrees may be displayed on the display screen 112 and/or the display screen 122. Additionally or alternatively, the “bend radius” metric tracks whether a portion (or more than one portion) of the virtual instrument 715A is bent in a curvature that is too sharp to allow a device to pass through a lumen of the virtual instrument 715A. In some examples, a bend indicator may be displayed on the display screen 112 and/or the display screen 122. Portions of the bend indicator may turn a different color, such as yellow or red, when the portion (or more than one portion) of the virtual instrument 715A is bent in a curvature that is too sharp to allow a device to pass through the lumen of the virtual instrument 715A. The “bend radius” metric may track the number of yellow/red portions in the bend indicator. The number of yellow/red portions in the bend indicator may be updated in real time. For example, when a portion of the virtual instrument 715A is bent in a curvature that is too sharp to allow a device to pass through the lumen of the virtual instrument 715A, the “bend radius” metric may increase by an increment of “one,” such as from “0” to “1.” The user's goal may be to minimize the number of yellow/red portions in the bend indicator. Additionally or alternatively, the user's goal may be to minimize a length of the yellow/red portions.

Various examples of bend indicators, as well as related indicators for monitoring parameters other than bend, are further described in U.S. Provisional Patent Application No. 62/357,217, filed on Jun. 30, 2016, and entitled “Graphical User Interface for Displaying Guidance Information During an Image-Guided Procedure,” which is incorporated by reference herein in its entirety. Further information regarding the bend indicator may be found in International Application No. WO 2018/195216, filed on Apr. 18, 2018, and entitled “Graphical User Interface for Monitoring an Image-Guided Procedure,” which is incorporated by reference herein in its entirety.

As discussed above, the input control device 136 controls bending of the distal portion of the virtual instrument 715A, and the input control device 134 controls insertion of the virtual instrument 715A. In some embodiments, the plurality of performance metrics track the user's proficiency in using various input devices during navigation and driving. The plurality of performance metrics 760 may include one or more additional metrics, such as an “incorrect use of user input device” metric, a “concurrent driving” metric 760B, an “eye tracking” metric, a “frequency of control utilization” metric, a “free-spinning of user input device” metric, or the like. Any one or more of these metrics (or any other metrics not listed) may be displayed on the display screen 112 and/or the display screen 122. Additionally or alternatively, any one or more of these metrics (or any other metrics not listed) may be tracked by the computing system 110 and/or the computing system 120, regardless of whether the metrics are displayed on the display screen 112 and/or the display screen 122. In some examples, the plurality of performance metrics 760 are not displayed on the display screen 112 while the user is performing an exercise. In such examples, the performance metrics 760 may be displayed when the user completes the exercise, which will be discussed in greater detail below.

In some embodiments, the “incorrect use of user input device” metric tracks the number of times the user incorrectly operates the input control device 136, for example. The number of times the user incorrectly operates the input control device 136 to attempt to insert or retract the virtual instrument 715A may be updated in real time. For example, when the user incorrectly operates the input control device 136 to attempt to insert or retract the virtual instrument 715A, the “incorrect use of user input device” metric may increase by an increment of “one,” such as from “0” to “1.” Additionally or alternatively, the “incorrect use of user input device” metric may track the amount of time the user incorrectly operates the input control device 136. This allows the system 110 and/or the system 120 to determine the total amount of time it takes the user to resume correct operation of the input control device 136.

In several cases, the “concurrent driving” metric 760B tracks the percentage of time when both input control devices 134, 136 are in motion at the same time. Concurrent driving may be more efficient because simultaneous insertion and articulation of the virtual instrument 715A may result in the virtual instrument 715A traveling to a target (e.g., the target 740A) faster than if the virtual instrument 715A is not simultaneously inserted and articulated. In some embodiments, the percentage of concurrent driving is determined by comparing the amount of time that both input control devices 134, 136 are in motion at the same time to the amount of time that only one of the input control devices 134, 136 is in motion. The user's goal may be to maximize the amount of concurrent driving and thus increase the concurrent driving percentage. In several embodiments, the “concurrent driving” metric 760B may be tracked for one or more exercises in one or more of the Basic Driving 1 Module, the Basic Driving 2 Module, the Airway Driving 1 Module, and the Airway Driving 2 Module. In some examples, the “concurrent driving” metric 760B may be tracked in one or more exercises that do not require concurrent driving. In such examples, if the user actuates both input control devices 134, 136 at the same time, the system 110 and/or the system 120 may instruct the user to stop his or her “concurrent driving.”

In some embodiments, the “free-spinning of user input device” metric tracks the number of times the input control device 134 rotates at least one full revolution in less than one second. As discussed above, the input control device 134 controls insertion of the virtual instrument 715A. The number of times the input control device 134 rotates at least one full revolution in less than one second may be updated in real time. For example, when the input control device 134 rotates at least one full revolution in less than one second, the “free-spinning of user input device” metric may increase by an increment of “one,” such as from “0” to “1.” When the input control device 134 rotates at least one full revolution in less than one second, the input control device 134 may be rotating at an angular velocity that is greater than a threshold angular velocity. In some cases, the threshold angular velocity may be 60 revolutions per minute but may be any other suitable angular velocity. When the input control device 134 rotates at an angular velocity greater than the threshold angular velocity, the “free-spinning of user input device” metric may increase by an increment of “one,” such as from “0” to “1.” The user's goal may be to minimize the number of times the input control device 134 rotates at an angular velocity that is greater than a threshold angular velocity.

In some embodiments, the “eye tracking” metric tracks the user's gaze, which allows the system 110 and/or the system 120 to determine which display screen (e.g., one of the display screens 112, 122) the user is looking at while performing an exercise (e.g., the exercise shown in the GUI 700A). The system 110 and/or the system 120 may also determine if the user is looking at one or both of the input control devices 134, 136. For example, the camera 118 of the system 110 and/or the camera 128 of the system 120 may track the user's gaze. Based on the tracked gaze, the system 110 and/or the system 120 may determine: (1) the percentage of time the user is looking at the display screen 112 when the virtual instrument 715A is traversing the virtual passageway 710A; (2) the percentage of time the user is looking at the display screen 122 when the virtual instrument 715A is traversing the virtual passageway 710A; and/or (3) the percentage of time the user is looking at one or both of the input control devices 134, 136 when the virtual instrument 715A is traversing the virtual passageway 710A. The system 110 and/or the system 120 may compare these percentages to determine how often the user is looking at the display screen 112 when the virtual instrument 715A is traversing the virtual passageway 710A.

In some cases, one or more indicators (e.g., messages, cues, etc.) may be presented to the user while the virtual instrument 715A is traversing the virtual passageway 710A. The indicator may provide a suggestion to the user regarding where the user should direct his or her gaze. The indicator(s) may be a textual indicator, an audible indicator, a haptic indicator, any other indicator, or any combination thereof. In examples when the indicator is a textual indicator, the textual indicator may be displayed on one or both of the display screens 112, 122. In such examples, the “eye tracking” metric may track whether the user looked at the textual indicator. For example, the camera 118 and/or the camera 128 may track the user's gaze. The system 110 and/or the system 120 may then determine whether the user looked at the textual indicator. The “eye tracking” metric may also track whether the user adhered to the suggestion provided by the textual indicator.

In some embodiments, the “eye tracking” metric may be used by the system 110 and/or the system 120 to draw the user's attention to one or more suboptimal events (e.g., bleeding, a perforation, a blockage, etc.) that may occur while the virtual instrument 715A is traversing the virtual passageway 710A. For example, the system 110 and/or the system 120 may determine the location on the display screen 112 and/or the display screen 122 the user's gaze is focused. The system 110 and/or the system 120 may then present a message to the user at the location where the user's gaze is focused. The message may instruct the user to turn his or her attention to the suboptimal event(s)—e.g., a location on the display screen 112 and/or the display screen 122 where the suboptimal event is displayed.

In some examples, an indicator may be presented when contact occurs between the distal tip of the virtual instrument 715A and the wall of the virtual passageway 710A. As seen in FIG. 8, the display screen 112 may display an indicator 790 along an edge of the display screen 112. The indicator 790 may indicate the general area where contact occurs between the distal tip of the virtual instrument 715A and the wall of the virtual passageway 710A. For example, based on the location of the indicator 790 shown in FIG. 8, the distal end of the virtual instrument 715A contacted the wall of the virtual passageway 710A in the general area of the lower left quadrant (e.g., the −X,−Y quadrant) of the virtual passageway 710A in an image reference frame I. In several examples, the indicator 790 may be overlaid on the portion 770. In some cases, the indicator 790 may be a different color than the portion 770 (e.g., red, orange, yellow, etc.). Additionally or alternatively, the indicator 790 may include a pattern, such as cross-hatching. In some embodiments, the indicator 790 may be presented in any other suitable format (e.g., a textual notification on the display screen 112, an audible notification, haptic feedback, etc.).

Additionally or alternatively, the indicator 790 may be altered by an effect, such as exploding the indicator 790, imploding the indicator 790, changing an opacity of the indicator 790, changing a color of the indicator 790, the indicator 790 fades, the indicator 790 disappears, etc. The indicator 790 may be displayed with any one or more of the effects described above. In some cases, the display screen 112 and/or the display screen 122 may display the indicator 790 to indicate the user's performance status with respect to any one or more of the performance metrics discussed above.

In some embodiments, the system 110 and/or the system 120 may evaluate the user's performance with respect to any combination of the metrics described above to provide an overall score of the user's performance. In some cases, one or more of the metrics may be weighted to emphasize the importance of certain metrics over other metrics. In other cases, each metric may have equal weight. The overall score may include one or more sub-scores. For example, the overall score may include a driving sub-score to evaluate how successfully the virtual instrument 715A was driven through the virtual passageway 710A. The system 110 and/or the system 120 may determine the driving sub-score by evaluating one or more metrics related to collisions between the virtual instrument 715A and the wall of the virtual passageway 710A, force exerted by the virtual instrument 715A onto the wall of the virtual passageway 710A, hitting targets (e.g., the targets 720A), and/or any other relevant metrics or combinations of metrics. In some examples, the overall score may include a path navigation sub-score to evaluate how successfully the traversal path of the virtual instrument 715A matched a planned path (e.g., the path 730A). The system 110 and/or the system 120 may determine the path navigation sub-score by evaluating one or more metrics related to an optimal traversal path, an optimal parking location, an optimal position, orientation, pose, and/or shape of the virtual instrument 715A, and/or any other relevant metrics or combinations of metrics. The overall score may additionally or alternatively include an input control device sub-score to evaluate how successfully the user operated the input control devices 134, 136. The system 110 and/or the system 120 may determine the driving sub-score by evaluating one or more metrics related to the operation of the input control devices 134, 136 and/or any other relevant metrics or combinations of metrics.

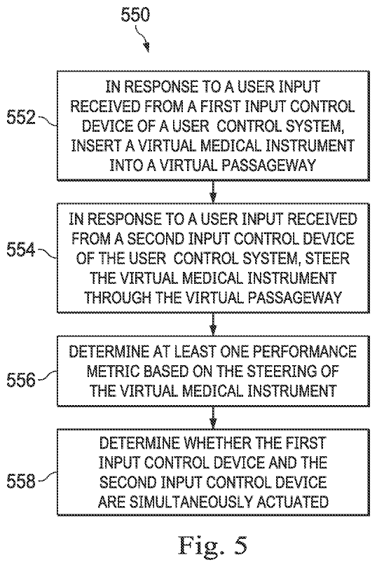

FIG. 5 illustrates a method 550 for controlling a virtual instrument in the system 100 according to some embodiments. The method 550 is illustrated as a set of operations or processes 552 through 558 and is described with continuing reference to at least FIGS. 1A, 1B, 3A-3E, and 6-10. As shown in FIG. 5, at a process 552, a virtual instrument (e.g., the virtual instrument 615) is inserted into a virtual passageway (e.g., the virtual passageway 610) in response to a user input received from at least the input control device 134. During or after the virtual instrument is inserted into the virtual passageway, at a process 554, the virtual instrument is steered through the virtual passageway in response to a user input received from at least the input control device 136. At a process 556, the computing system 110 and/or the computing system 120 determines at least one performance metric (e.g., the “targets” metric 760A, the “concurrent driving” metric 760B, the “collisions” metric 760C, the “time to complete” metric 760D, etc.) based on the steering of the virtual instrument. At a process 558, the computing system 110 and/or the computing system 120 determines whether the input control devices 134, 136 are simultaneously actuated. In some examples, this assists with the system 110's and/or the system 120's tracking of the “concurrent driving” metric 760B.

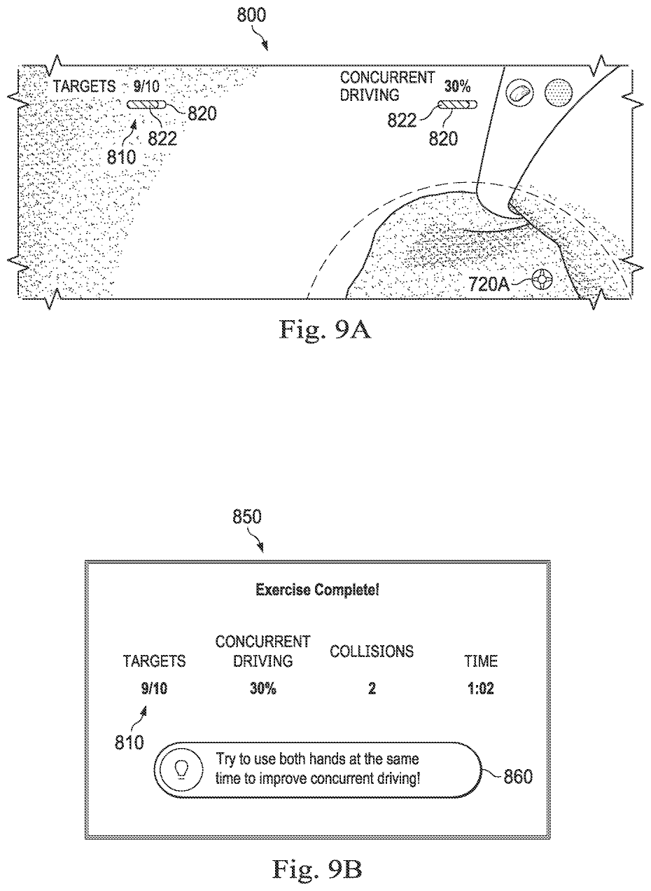

FIG. 9A illustrates a portion 800 of a dynamic GUI (e.g., GUI 700A, 600) that may be displayed on the display screen 112. In some embodiments, the portion 800 may be displayed on the display screen 112 in place of the second portion 600B of the dynamic GUI 600. As discussed above, the second portion 600B illustrates a view from the distal tip of the virtual instrument 615. Similarly, the portion 800 illustrates a view from the distal tip of the virtual instrument 715A. The portion 800 may include a plurality of performance metrics 810, which may include any one or more of the performance metrics 760. The portion 800 may further include a progress bar 820 corresponding to each performance metric. In some embodiments, each progress bar 820 may indicate a completion progress of each performance metric. For example, the progress bar 820 corresponding to the “targets” metric 760A may indicate how many targets (e.g., the targets 720A) the virtual instrument 715A has contacted during the exercise. As each target is contacted, a progress indicator 822 of the progress bar 820 may incrementally fill up the progress bar 820 in real time. The progress indicator 822 may be a color (e.g., green, blue, red, etc.), a pattern, or any other visual indicator used to illustrate progress. In some examples, the progress bar 820 may be illustrated after the exercise is complete to illustrate the user's performance with respect to each performance metric for the particular exercise.

FIG. 9B illustrates a summary report 850 that may include a statistical summary of the user's performance of a particular exercise. The report 850 may be displayed on the display screen 112 and/or the display screen 122. In some embodiments, the report 850 is displayed after the user completes an exercise. In other embodiments, the report 850 may be displayed while the user is performing the exercise, and the metrics 810 may be updated in real time. As shown in FIG. 9B, the report 850 may further include an instruction icon 860, which may provide instructions and/or tips to help the user improve his or her performance. For example, the instruction icon 860 may suggest that the user actuate both input control devices 134, 136 at the same time to improve the “concurrent driving” score. The instruction icon 860 may provide any other suggestions/tips, as needed, to help improve the user's performance with respect to any one or more of the other metrics 810 and/or any of the additional metrics discussed above with respect to FIG. 8.

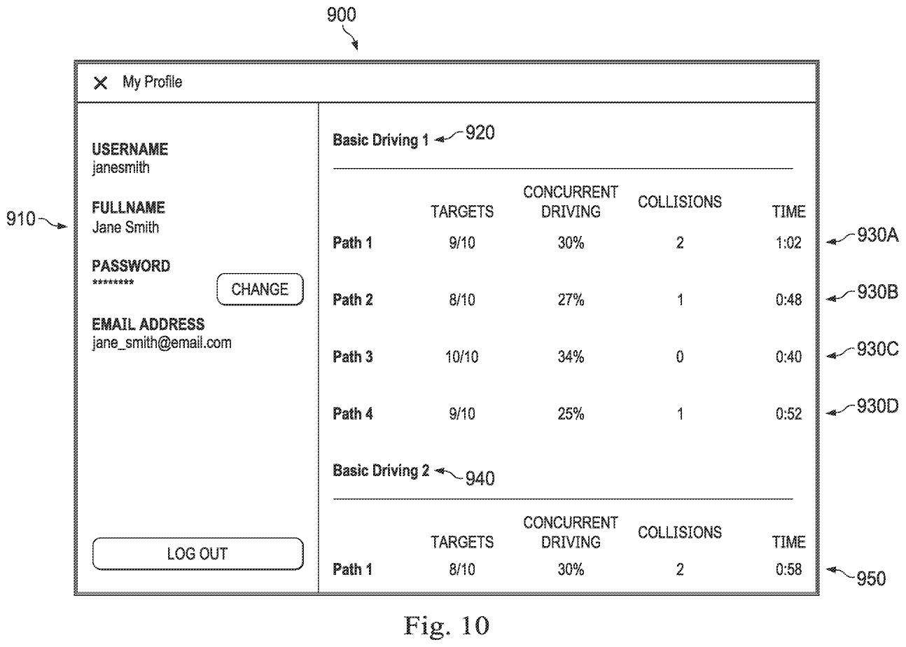

FIG. 10 illustrates a profile summary 900 that may be displayed on the display screen 112 and/or the display screen 122 according to some embodiments. In some examples, the profile summary 900 includes profile information 910, which may include identification information (e.g., username, actual name, password, email, etc.) for the current user logged in to the computing system 110 and/or the computing system 120. The profile summary 900 may also include module categories 920, 940. The module categories shown in the profile summary 900 may include the modules that were activated while the user was logged in to the system 110/120. In some embodiments, performance summaries 930A-930D, 950 may be included within the module categories. The performance summaries 930A-930D, 950 may correspond to respective exercises performed by the user, and the performance summaries 930A-930D may illustrate metrics for each exercise the user performed while the user was logged in to the system.

As shown in FIG. 10, the module category 920 represents the Basic Driving 1 Module. In some embodiments, each performance summary 930A-930D corresponds to an exercise performed by the user within the Basic Driving 1 Module. For example, the performance summary 930A corresponds to Exercise 1 in the Basic Driving 1 Module. The performance summary 930A may include performance metrics that illustrate the user's performance with respect to Exercise 1. The performance summary 930B may correspond to Exercise 2 in the Basic Driving 1 Module, the performance summary 930C may correspond to Exercise 3 in the Basic Driving 1 Module, and the performance summary 930D may correspond to Exercise 4 in the Basic Driving 1 Module. In some embodiments, the performance summary 950 corresponds to an exercise performed by the user within the Basic Driving 2 Module. For example, the performance summary 950 may correspond to Exercise 1 in the Basic Driving 2 Module.

In examples when an exercise is repeated one or more times, the performance summary for each repetition of the exercise may be included within the module category corresponding to the module that includes the repeated exercise. Additionally or alternatively, when an exercise is repeated, the metrics for each exercise run may be averaged together, and the performance summary for that exercise may list the average metrics for that exercise. Additionally or alternatively, when an exercise is repeated, the metrics for the user's most successful exercise run and the metrics for the user's least successful exercise run may be displayed.

In some examples, one or more of the user's supervisors may log in to the system 110 and/or the system 120 to view the user's performance. For example, when the supervisor is logged in, a summary chart may be displayed illustrating the performance metrics for one or more exercises the user has completed. The system may also display the performance metrics for other users under the supervisor's supervision. In this way, the system may illustrate a comparison of the performances of more than one user.

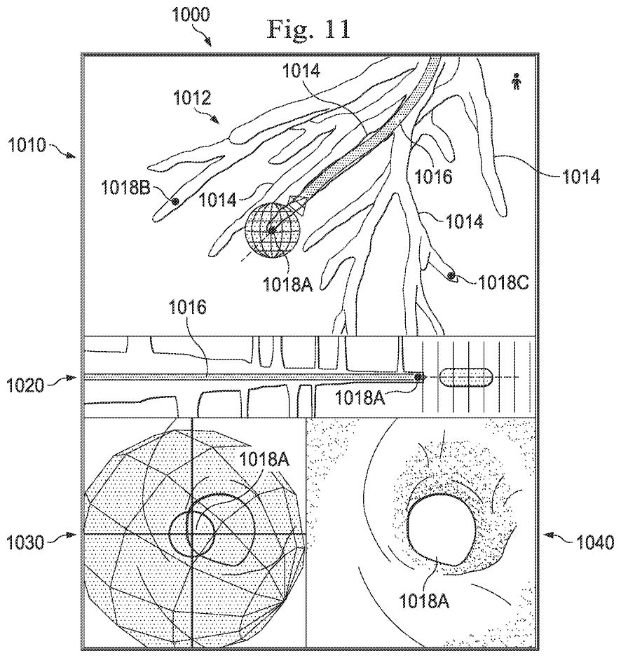

FIG. 11 illustrates a graphical user interface (GUI) 1000 displayable on one or both of the display screens 112, 122 according to some embodiments. In some embodiments, the GUI 1000 may include a global airway view 1010, a reduced anatomical model 1020, a navigational view 1030, and an endoscopic view 1040. In some examples, the global airway view 1010 includes a 3D virtual patient anatomical model 1012, which may include a plurality of virtual passageways 1014, shown from a global perspective. The reduced anatomical model 1020 includes an elongated representation of a planned route to the target location, in a simplified 2D format. The navigation view 1030 includes a zoomed-in view of the target from the 3D virtual patient anatomical model 1012. The endoscopic view 1040 includes a view from a distal tip of the virtual instrument 1016.

The GUI 1000 may be displayed when the Airway Driving 1 Module and/or the Airway Driving 2 Module is actuated. A goal of these modules may be to provide training to the user regarding navigating a medical instrument through various anatomical passageways while using the GUI 1000. For example, the GUI 1000 may assist the user with respect to guidance of the medical instrument. In some embodiments, the user may activate the Airway Driving 1 Module by selecting the module icon 210D on the display screen 122. After the module icon 210D is selected, the display screen 122 may then display a GUI displaying the exercises that are included in the Airway Driving 1 Module. In some embodiments, the Airway Driving 1 Module includes five exercises, but any other number of exercises may be included. The user may activate the first exercise of the Airway Driving 1 Module, which may be a first airway navigation exercise, by selecting a first exercise icon on the display screen 122. The first exercise may be a first airway navigation exercise.

In several examples, the global airway view 1010 includes a virtual patient anatomical model 1012, which may include a plurality of virtual passageways 1014. In some cases, the virtual passageways of the plurality of virtual passageways 1014 are virtual anatomical passageways. The patient anatomical model 1012 may be generic (e.g., a pre-determined model stored within a computing system such as computing system 120, or randomly generated by the computing system 110 and/or the computing system 120). In other embodiments, the patient anatomical model 1012 may be generated from a library of patient data. In other embodiments the patient anatomical model 1012 may be generated from CT data for a specific patient. For example, a user preparing for a specific patient procedure may load data from a CT scan taken from the patient on which the procedure is to be performed. In some examples, the patient anatomical model 1012 may be static in the exercises of the Airway Driving 1 Module.

In some embodiments, a virtual instrument 1016, which may be substantially similar to the virtual instrument 615 or 715A-E, traverses the patient anatomical model 1012 in different exercises in the Airway Driving 1 Module. For example, the patient anatomical model 1012 may include several targets 1018A-1018C. Each target may correspond to a different exercise within the Airway Driving 1 or Airway Driving 2 Module. Thus, in some examples, when the user switches between exercises in the Airway Driving 1 Module, the user may navigate the virtual instrument 1016 to a different target based on which exercise is activated. For example, when the first exercise in the Airway Driving 1 Module is activated, the user may navigate the virtual instrument 1016 through the virtual anatomical passageway 1014 to the target 1018A. When the second exercise in the Airway Driving 1 Module is activated, the user may navigate the virtual instrument 1016 through a virtual anatomical passageway to the target 1018B. The second exercise may be a second airway navigation exercise. When the third exercise in the Airway Driving 1 Module is activated, the user may navigate the virtual instrument 1016 through a virtual anatomical passageway to the target 1018C. The third exercise may be a third airway navigation exercise.

In some embodiments, when the system 100 switches from one exercise to another within the Airway Driving 1 Module, the system 100 may automatically reset the distal tip of the virtual instrument 1016 to a proximal location in the patient anatomical model 1012. For example, the distal tip of the virtual instrument 1016 may be reset to the main carina. Thus, in such embodiments, each exercise starts with the virtual instrument 1016 positioned at the same or similar proximal location within the patient anatomical model 1012. In other embodiments, when the system 100 switches between exercises within the Airway Driving 1 Module, a subsequent exercise starts with the virtual instrument 1016 in a same current position as the end of a previous exercise. The system may instruct the user to retract the virtual instrument 1016 from the target the user reached in the previous exercise (e.g., the target 1018A) to the main carina or some other proximal location (e.g., a closest bifurcation proximal to a subsequent target, e.g. the target 1018B or the target 1018C) within the patient anatomical model 1012 and to then navigate the virtual instrument 1016 to the target in the subsequent exercise (e.g., the target 1018B or the target 1018C). In such embodiments, an intermediate target or a plurality of intermediate targets (not shown) in the virtual passageway 1014, for example, may be presented in the GUI 1000 to help guide the user to the retraction point.

In some examples, as the virtual instrument 1016 advances toward a target (e.g., the target 1018A), the reduced anatomical model view, the navigational view 1030, and the endoscopic view 1040 may each be updated in real time to show the virtual instrument 1016 advancing toward the target 1018A. In several embodiments, the endoscopic view 1040 illustrates a view from a distal tip of the virtual instrument 1016.

The endoscopic view 1040 may be substantially similar to the view shown in the second portion 600B of the GUI 600 (FIG. 6). In such embodiments, the navigational view 1030 may represent a virtual view of the endoscopic view 1040. In some embodiments, the computing system 100 and/or the computing system 120 may offset the navigational view 1030 from the endoscopic view 1040 by a predetermined amount to simulate the offset that occurs between the navigational view and the endoscopic view in the system GUI that is used in an actual medical procedure. The offset may be applied in an x-direction, a y-direction, and/or a diagonal direction. Additional information regarding the system GUI may be found in International Application No. WO 2018/195216, filed on Apr. 18, 2018, and entitled “Graphical User Interface for Monitoring an Image-Guided Procedure,” which is incorporated by reference herein in its entirety.

In several embodiments, the exercises in the Airway Driving 2 Module may include the same patient anatomy and the same targets as those used in the Airway Driving 1 Module. As discussed above, the patient anatomical model 1012 may be static in the exercises of the Airway Driving 1 Module. In some embodiments, the computing system 110 and/or the computing system 120 applies simulated patient motion to the patient anatomical model 1012 in the exercises of the Airway Driving 2 Module. The simulated patient motion may be applied to simulate respiration, circulation, and/or a combination of both respiration and circulation. The simulated patient motion may simulate how respiration and/or circulation may affect (e.g., deform) the patient anatomical model 1012. To simulate patient motion, the system 110 and/or the system 120 may apply a sine-wave pattern to the patient anatomical model 1012 in an insertion direction (e.g., an axial direction), in a radial direction, and/or in both the insertion and radial directions. In some examples, the simulated motion may be present in one or more of the global airway view 1010, the reduced anatomical model 1020, the navigational view 1030, and the endoscopic view 1040.

In some embodiments, the simulated motion may be scaled based on the position of the distal portion of the virtual instrument 1016 within the patient anatomical model 1012. For example, if the virtual instrument 1016 is in a portion of the patient anatomical model 1012 that is close to the heart, then the simulated motion may represent circulation more than respiration. In other examples, as the virtual instrument 1016 moves toward more peripheral virtual passageways of the patient anatomical model 1012, the simulated motion may represent respiration more than circulation. In some cases, the degree of the simulated motion may be lower when the virtual instrument 1016 is in a distal virtual passageway than when the virtual instrument 1016 is in a more proximal virtual passageway (e.g., closer to the main carina).

In some examples, a circulation cycle occurs at a shorter frequency than a respiration cycle. For example, four circulation cycles may occur for every one respiration cycle. Other frequencies may also be simulated, such as three circulation cycles per respiration cycle, five circulation cycles per respiration cycle, etc. The simulated motion may be scaled to account for the difference in cycle frequencies. For example, the simulated motion may represent circulation more frequently than the simulated motion represents respiration.

In some embodiments, the GUI 1000 may display any one or more of the performance metrics discussed above, such as the “concurrent driving” metric, the “collision” metric, the “total time” metric, etc. The metrics may be displayed during and/or after the user performs each exercise.

In some embodiments, the components discussed above may be used to train a user to control a teleoperated system in a procedure performed with the teleoperated system as described in further detail below. The teleoperated system may be suitable for use in, for example, surgical, teleoperated surgical, diagnostic, therapeutic, or biopsy procedures. While some embodiments are provided herein with respect to such procedures, any reference to medical or surgical instruments and medical or surgical methods is non-limiting. The systems, instruments, and methods described herein may be used for animals, human cadavers, animal cadavers, portions of human or animal anatomy, non-surgical diagnosis, as well as for industrial systems and general robotic, general teleoperational, or robotic medical systems.

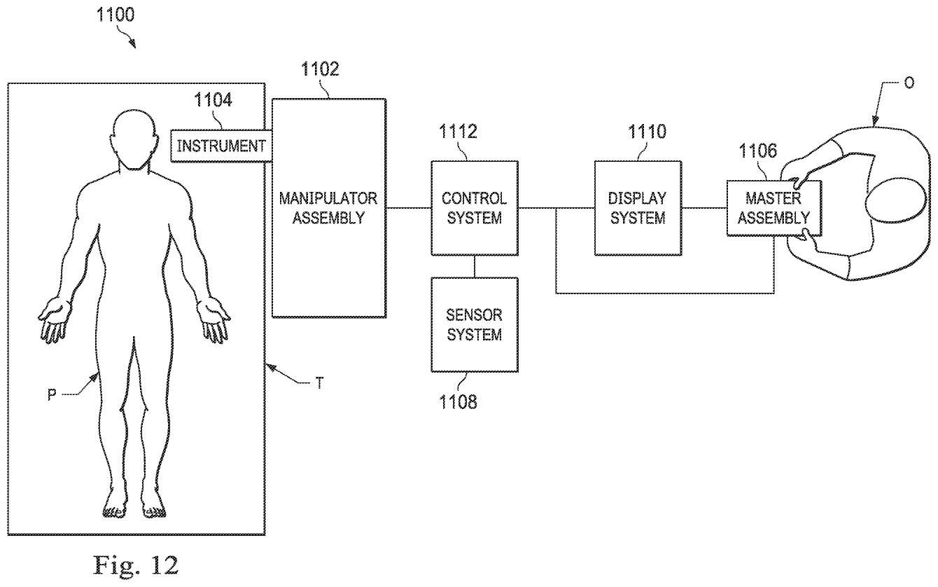

As shown in FIG. 12, a medical system 1100 generally includes a manipulator assembly 1102 for operating a medical instrument 1104 in performing various procedures on a patient P positioned on a table T. The manipulator assembly 102 may be teleoperated, non-teleoperated, or a hybrid teleoperated and non-teleoperated assembly with select degrees of freedom of motion that may be motorized and/or teleoperated and select degrees of freedom of motion that may be non-motorized and/or non-teleoperated. The medical system 1100 may further include a master assembly 1106, which generally includes one or more control devices for controlling manipulator assembly 1102. Manipulator assembly 1102 supports medical instrument 1104 and may optionally include a plurality of actuators or motors that drive inputs on medical instrument 1104 in response to commands from a control system 1112. The actuators may optionally include drive systems that when coupled to medical instrument 1104 may advance medical instrument 1104 into a naturally or surgically created anatomic orifice.

Medical system 1100 also includes a display system 1110 for displaying an image or representation of the surgical site and medical instrument 1104 generated by sub-systems of sensor system 1108. Display system 1110 and master assembly 1106 may be oriented so operator O can control medical instrument 1104 and master assembly 1106 with the perception of telepresence. Additional information regarding the medical system 1100 and the medical instrument 1104 may be found in International Application No. WO 2018/195216, filed on Apr. 18, 2018, and entitled “Graphical User Interface for Monitoring an Image-Guided Procedure,” which is incorporated by reference herein in its entirety.

The system 100 discussed above may be used to train the user to operate the medical instrument 1104. For example, the system 100 may provide training to the user to help the user learn how to operate the master assembly 1106 to control the manipulator assembly 1102 and the medical instrument 1104. Additionally or alternatively, the system 100 may teach the user how to control the medical instrument 1104 while using the display system 1110 before and/or during a medical procedure.

The singular forms “a”, “an”, and “the” are intended to include the plural forms as well, unless the context indicates otherwise. And the terms “comprises,” “comprising,” “includes,” “has,” and the like specify the presence of stated features, steps, operations, elements, and/or components but do not preclude the presence or addition of one or more other features, steps, operations, elements, components, and/or groups. Components described as coupled may be electrically or mechanically directly coupled, or they may be indirectly coupled via one or more intermediate components. The auxiliary verb “may” likewise implies that a feature, step, operation, element, or component is optional.

Elements described in detail with reference to one embodiment, implementation, or application optionally may be included, whenever practical, in other embodiments, implementations, or applications in which they are not specifically shown or described. For example, if an element is described in detail with reference to one embodiment and is not described with reference to a second embodiment, the element may nevertheless be claimed as included in the second embodiment. Thus, to avoid unnecessary repetition in the following description, one or more elements shown and described in association with one embodiment, implementation, or application may be incorporated into other embodiments, implementations, or aspects unless specifically described otherwise, unless the one or more elements would make an embodiment or implementation non-functional, or unless two or more of the elements provide conflicting functions.

A computer is a machine that follows programmed instructions to perform mathematical or logical functions on input information to produce processed output information. A computer includes a logic unit that performs the mathematical or logical functions, and memory that stores the programmed instructions, the input information, and the output information. The term “computer” and similar terms, such as “processor” or “controller” or “control system”, are analogous.

Although some of the examples described herein refer to surgical procedures or instruments, or medical procedures and medical instruments, the techniques disclosed apply to non-medical procedures and non-medical instruments. For example, the instruments, systems, and methods described herein may be used for non-medical purposes including industrial uses, general robotic uses, and sensing or manipulating non-tissue work pieces. Other example applications involve cosmetic improvements, imaging of human or animal anatomy, gathering data from human or animal anatomy, and training medical or non-medical personnel. Additional example applications include use for procedures on tissue removed from human or animal anatomies (without return to a human or animal anatomy), and performing procedures on human or animal cadavers. Further, these techniques can also be used for surgical and nonsurgical medical treatment or diagnosis procedures.

Further, although some of the examples presented in this disclosure discuss teleoperational robotic systems or remotely operable systems, the techniques disclosed are also applicable to computer-assisted systems that are directly and manually moved by operators, in part or in whole.

Additionally, one or more elements in embodiments of this disclosure may be implemented in software to execute on a processor of a computer system such as a control processing system. When implemented in software, the elements of the embodiments of the present disclosure are essentially the code segments to perform the necessary tasks. The program or code segments can be stored in a processor readable storage medium (e.g., a non-transitory storage medium) or device that may have been downloaded by way of a computer data signal embodied in a carrier wave over a transmission medium or a communication link. The processor readable storage device may include any medium that can store information including an optical medium, semiconductor medium, and magnetic medium. Processor readable storage device examples include an electronic circuit, a semiconductor device, a semiconductor memory device, a read only memory (ROM), a flash memory, an erasable programmable read only memory (EPROM); a floppy diskette, a CD-ROM, an optical disk, a hard disk, or other storage device. The code segments may be downloaded via computer networks such as the Internet, Intranet, etc.

Note that the processes and displays presented may not inherently be related to any particular computer or other apparatus, and various systems may be used with programs in accordance with the teachings herein. The required structure for a variety of the systems discussed above will appear as elements in the claims. In addition, the embodiments of the present disclosure are not described with reference to any particular programming language. It will be appreciated that a variety of programming languages may be used to implement the teachings of the present disclosure as described herein.

While certain example embodiments of the present disclosure have been described and shown in the accompanying drawings, it is to be understood that such embodiments are merely illustrative of and not restrictive to the broad disclosed concepts, and that the embodiments of the present disclosure not be limited to the specific constructions and arrangements shown and described, since various other modifications may occur to those ordinarily skilled in the art.

1. A system comprising:
a user control system including at least one input control device for controlling motion of a virtual medical instrument through a virtual passageway;
a display for displaying a graphical user interface and a plurality of training modules, the graphical user interface including a representation of the virtual medical instrument and a representation of the virtual passageway; and
a non-transitory, computer-readable storage medium that stores a plurality of instructions executable by one or more computer processors, the instructions for performing operations comprising:
navigating the virtual medical instrument through the virtual passageway based on commands received from the user control system; and
evaluating one or more performance metrics for tracking the navigation of the virtual medical instrument through the virtual passageway.

2. The system of claim 1, wherein the virtual passageway is defined by a plurality of sequentially-aligned virtual targets.

3. (canceled)

4. The system of claim 1, wherein the performance metric tracks a number of times contact occurs between the virtual medical instrument and a wall of the virtual passageway.

5. The system of claim 4, wherein the performance metric further tracks for each of the number of times contact occurs, a length of time the virtual medical instrument makes contact with the wall of the virtual passageway.

6. (canceled)

7. The system of claim 4, wherein the performance metric further tracks deformation of the virtual medical instrument during the contact.

8. The system of claim 4, wherein contact is determined by a collision force exerted on the wall of the virtual passageway by the virtual medical instrument exceeding a threshold collision force.

9. The system of claim 8, wherein the collision force is based on a distance the virtual medical instrument travels beyond the wall of the virtual passageway.

10. The system of claim 4, wherein the graphical user interface further includes a representation of the contact on the representation of the virtual passageway.

11. The system of claim 1, wherein the virtual passageway includes a plurality of sequentially-aligned virtual targets within a lumen of the virtual passageway.

12. The system of claim 11, wherein the plurality of sequentially-aligned virtual targets are aligned along a traversal path within the virtual passageway, the traversal path being different than a longitudinal axis of the virtual passageway.

13. The system of claim 1, wherein the instructions for performing operations further comprise determining an optimal traversal path of the virtual passageway.

14. The system of claim 13, wherein the optimal traversal path includes a final target and an optimal position of the virtual medical instrument at the final target.

15. (canceled)

16. The system of claim 13, wherein the virtual passageway is defined by a plurality of sequentially-aligned virtual targets aligned along the optimal traversal path of the virtual passageway.

17. The system of claim 11, wherein the performance metric tracks a number of virtual targets of the plurality of sequentially-aligned virtual targets contacted by the virtual medical instrument.

18. The system of claim 11, wherein the performance metric tracks a number of virtual targets of the plurality of sequentially-aligned virtual targets missed by the virtual medical instrument.

19. The system of claim 18, wherein the performance metric tracks a number of times the virtual medical instrument is retracted after insertion past a missed target.

20. The system of claim 13, wherein the performance metric tracks a number of times the virtual medical instrument deviates from the optimal traversal path or a length of time the virtual medical instrument deviates from the optimal traversal path.

21. (canceled)

22. The system of claim 1, wherein the at least one input control device includes a first input device and a second input device, and wherein the performance metric tracks an amount of time the first input device and the second input device are simultaneously actuated.

23. The system of claim 1, wherein the performance metric tracks a number of times the at least one input control device rotates past a threshold angular velocity.

24. The system of claim 1, wherein the display includes a first display device and a second display device, wherein the first display device displays the graphical user interface and the second display device displays the plurality of training modules.

25-28. (canceled)
